(19) United States
(12) Patent Application Publication
(10) Pub. No.: US 2024/0410726 A1
(43) Pub. Date: Dec. 12, 2024

(54) SYNCHRONIZING MULTI-MODAL SENSOR MEASUREMENTS FOR OBJECT TRACKING IN AUTONOMOUS SYSTEMS AND APPLICATIONS

(71) Applicant: NVIDIA CORPORATION, Santa Clara, CA (US)

(72) Inventors: Parthiv PARIKH, San Jose, CA (US); Yongqing LIANG, San Jose, CA (US); Mehmet Kemal KOCAMAZ, San Jose, CA (US); Alessandro FERRARI, Brescia (IT); Daniel Per Olof SVENSSON, Gothenburg (SE)

(21) Appl. No.: 18/331,857

(22) Filed: Jun. 8, 2023

(51) Int. Cl. G01D 21/02

(52) U.S. Cl. CPC G01D 21/02

(57) ABSTRACT

In various examples, disclosed techniques introduce a time-window based sensor measurement scheduling engine that determines an ordering of measurements received from multiple sensors. The measurements may be sorted by detection time and submitted in sorted order to a sensor fusion system. Upon receiving measurements from sensors, the scheduling engine determines a current time window between a most recently-submitted measurement and a most recent camera measurement. Any measurements from other sensors, such as RADAR, that are less than a threshold amount of time ahead of or behind the current time window can be extrapolated to a time in the current time window for comparison with camera measurements. The scheduling engine then sorts the selected measurements based on their timestamps in the current time window, and submits the selected measurements to the fusion system in sorted order. The system may then perform downstream operations, such as object tracking, using the sorted measurements.

### BACKGROUND

An autonomous or semi-autonomous vehicle or machine is equipped with a perception system that tracks objects in the three-dimensional (3D) environment using sensors of multiple different types. The sensors can include, for example, cameras, LiDAR, ultrasonic, and/or RADAR. Because each type of sensor has strengths and weaknesses, the measurements from these different sensor modalities may be combined using a multi-sensor fusion system. The sensor fusion system receives and combines the measurements from multiple sensors to accurately determine object characteristics, such as position, velocity and orientation. The perception system may include a tracking system, which may generate object tracking information based on sensor data received from the sensor fusion system. This object tracking information may include a list of objects, where the information for individual objects may include measurements corresponding to various characteristics-such as object position, velocity, acceleration, and so on.

The sensor fusion system relies on the measurements being received in an order dependent on sensor detection time. The “detection time” associated with a measurement made by a sensor as used herein refers to a time that is provided by the sensor, and is based on a time at which a detection by the sensor occurred. For example, the detection time can be the time at which the sensor detected an object or captured an image of an object. Thus the detection time can indicate a time at which the measurement associated with the detection time was generated using the sensor. The measurements from the sensors can arrive at the fusion system in an order different from detection time order. That is, the measurements arrive at the fusion system in an asynchronous manner, and the arrival time of a measurement is not necessarily the same as the detection time. For example, there can be an indefinite delay between the detection time of a measurement and the time at which the measurement arrives at the fusion system. Each sensor may provide measurements at a different frequency with variable delay because of hardware issues, and sensor perception pipelines may also introduce processing delay.

Some existing fusion systems attempt to sort the measurements by detection time to account for this situation. However, some relevant measurements may not be received by the fusion system at the time the system attempts to determine the ordering. Waiting for a substantial amount of time for measurements to arrive is not generally feasible, since fusion systems often run at a fixed frequency, with fixed-length fusion cycles that are short in duration so that the fusion system can produce results in a timely manner. Thus, delaying the fusion system output to wait for measurements from all sensors is not suitable for real-time or near real-time applications.

Another approach to determining an ordering of received measurements according to detection times of the measurements involves sorting the measurements that arrive within a particular fusion cycle by their associated detection times, and providing the sorted measurements to the fusion system during the fusion cycle. Although sorting the measurements by detection time within a cycle can successfully reorder the measurements in some cases-such as measurements being out of order over a short period of time-such sorting does not solve the problem in a number of common cases. For example, sorting within a cycle may not produce a correct ordering of measurements if one sensor is generating measurements at a substantially higher frequency than another sensor. Measurements from sensor A can be reported to the fusion system much faster than measurements from sensor B if sensor A has a lower latency post processing timeline. Although the fusion system receives measurements from both sensors, the received measurements from sensor A are always newer than the received measurements from sensor B. When a measurement has been processed, the fusion system drops any older sensor measurements to avoid inconsistent states. Thus, if the received measurements from sensor A are always newer than those from sensor B, the measurements from sensor B may be dropped, leaving only the measurements from sensor A to be processed. This process may result in a substantial number of measurements being dropped, which may have an impact on the accuracy or precision of the underlying systems.

In another example, measurements from sensor B are consistently delayed compared to sensor A by some amount of time. In this example, the sensor B measurements may arrive out of order and may be dropped because newer measurements from sensor A have been processed prior to receiving the measurements from sensor B. Approaches such as sorting the measurements within a cycle do not produce a correct ordering of the measurements by detection time if the measurements received from the sensors are out of order across sensors. As a result, in approaches that sort measurements within a cycle, there may be extended periods of time during which no measurements are passed to the sensor fusion system from particular sensors, which may result in reduced accuracy or precision for downstream tasks-such as object tracking.

As such, a need exists in autonomous and semi-autonomous systems for more effective techniques for ensuring that measurements from sensors are provided to a sensor fusion system in order, according to sensor detection time, and without dropping substantial numbers of measurements.

### SUMMARY

Embodiments of the present disclosure relate to processing asynchronous sensor measurements received from multiple sensors in order of measurement detection times. The techniques described herein include receiving a plurality of input measurements, individual input measurements of the plurality of input measurements being associated with a respective sensor. The techniques also include identifying a current time window having a lower boundary determined based at least on a first timestamp of a first measurement generated using a first sensor of a first sensor type and provided to a sensor data recipient, the current time window further having an upper boundary determined based at least on a second timestamp of a second measurement included in the plurality of input measurements, the second measurement being generated using a second sensor. The techniques further include determining a plurality of output measurements in the current time window, the plurality of output measurements including a third measurement generated using the first sensor and having a third timestamp in the current time window, the plurality of output measurements further including a predicted measurement associated with the second sensor, the predicted measurement extrapolated from an actual measurement generated using the second sensor, the actual measurement having a fourth timestamp in a second time window adjacent to the current time window. The techniques further include sorting the plurality of output measurements based at least on the respective timestamp associated with the output measurements. The techniques further include performing one or more operations using a machine based at least on the sorted plurality of output measurements.

One technical advantage of the disclosed techniques relative to prior solutions is the ability to accurately track objects using input from multiple sensors that generate measurements at different and/or varying rates. Prior approaches do not process measurements from multiple sensors in order of detection times if the measurements are out of order across sensors, as can occur when sensors generate measurements at different and/or varying rates. Further, prior approaches can drop a substantial number of measurements in certain timing scenarios, thereby reducing object tracking accuracy. The disclosed scheduler uses a time window for measurements and thus can accommodate a wider range of input timestamps. The scheduler correctly sorts the measurements received from multiple sensors into an order based on detection times of the measurements, even if the measurements are received at different rates or out of order across sensors. Thus, measurements across the wider range of timestamps can be sorted or extrapolated to align with the resulting processing schedule.

Another technical advantage of the disclosed techniques is that the disclosed scheduler does not use or allocate additional memory to buffer or otherwise store measurements. Instead, the scheduler receives measurements, sorts the measurements, and provides the measurements to a sensor fusion system during a fusion cycle, without allocating additional memory buffers in which to store the measurements. Accordingly, the disclosed techniques are faster and less resource-intensive than prior approaches that use memory to temporarily store, e.g., buffer, measurements prior to sorting and providing the measurements to a sensor fusion system. Another technical advantage of the disclosed techniques is the ability to perform accurate object tracking because measurements from multiple sensors are dropped less frequently than in prior approaches. Dropping fewer measurements results in improved accuracy and precision of sensor input processing and object tracking in autonomous and semi-autonomous systems.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

The present systems and methods for determining an ordering of inputs received from multiple sensors in autonomous and semi-autonomous systems and applications are described in detail below with reference to the attached drawing figures, wherein:

FIG. 1 illustrates a computing device configured to implement one or more aspects of various embodiments;

FIG. 2 is a more detailed illustration of the scheduling engine of FIG. 1, according to various embodiments;

FIG. 3 illustrates a current time window, a forward prediction time window, and a backward prediction time window, according to various embodiments;

FIG. 4 illustrates example RADAR measurements that arrive at a scheduling engine at different rates than camera measurements, according to various embodiments;

FIG. 5 illustrates an example execution of a scheduling engine for RADAR and camera measurements that arrive at different rates, according to various embodiments;

FIG. 6A illustrates a flow diagram of a method for sorting a set of sensor measurements based on sorted order of measurements from three types of sensors, according to various embodiments;

FIG. 6B illustrates a flow diagram of a method for scheduling delivery of sensor measurements to a sensor fusion engine, according to various embodiments;

FIG. 7A is an illustration of an example autonomous vehicle, in accordance with some embodiments of the present disclosure;

FIG. 7B is an example of camera locations and fields of view for the example autonomous vehicle of FIG. 7A, in accordance with some embodiments of the present disclosure;

FIG. 7C is a block diagram of an example system architecture for the example autonomous vehicle of FIG. 7A, in accordance with some embodiments of the present disclosure;

FIG. 7D is a system diagram for communication between cloud-based server(s) and the example autonomous vehicle of FIG. 7A, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

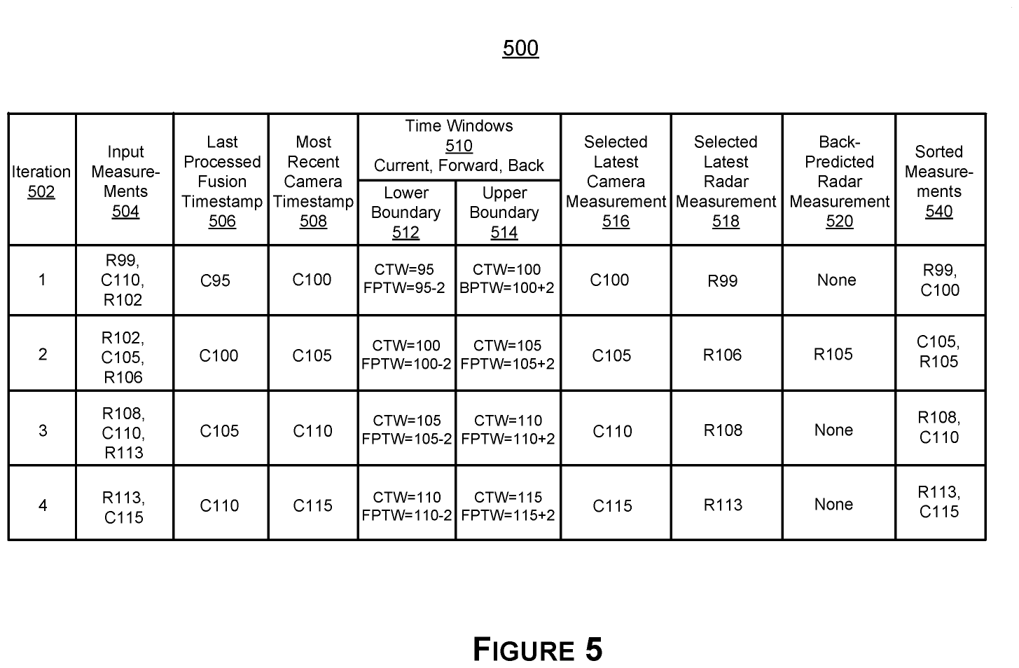

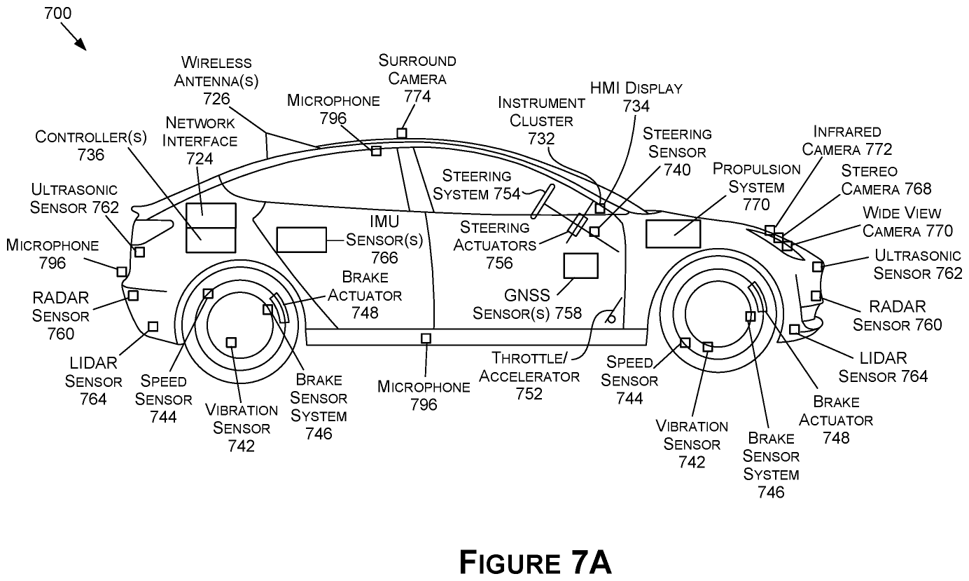

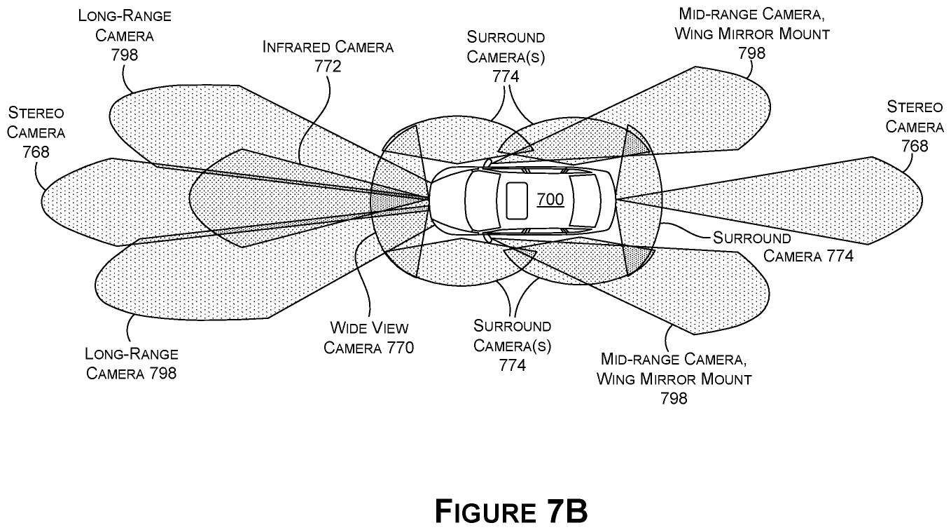

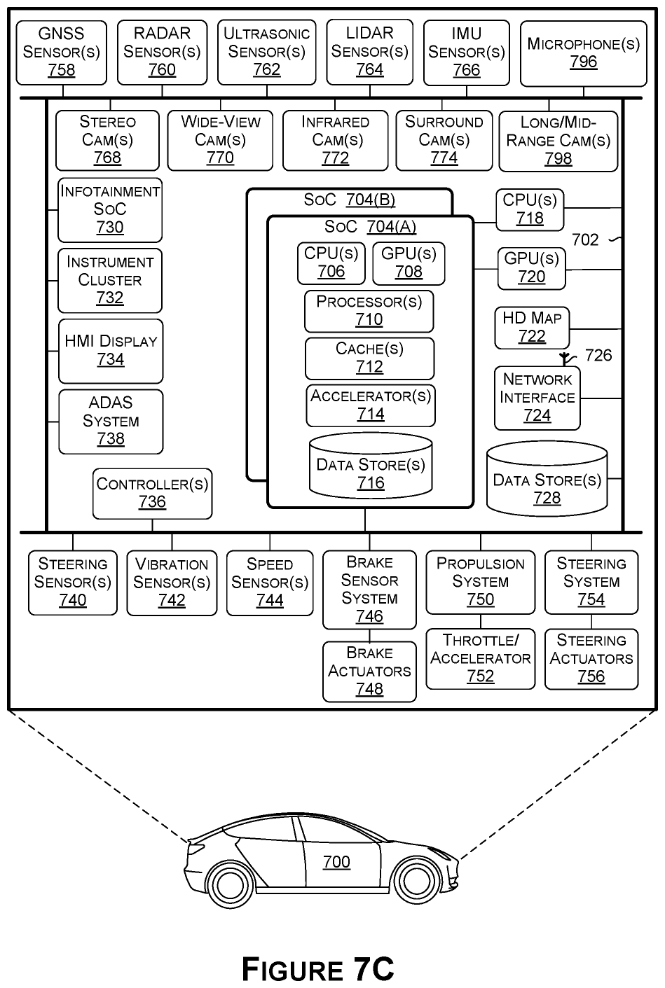

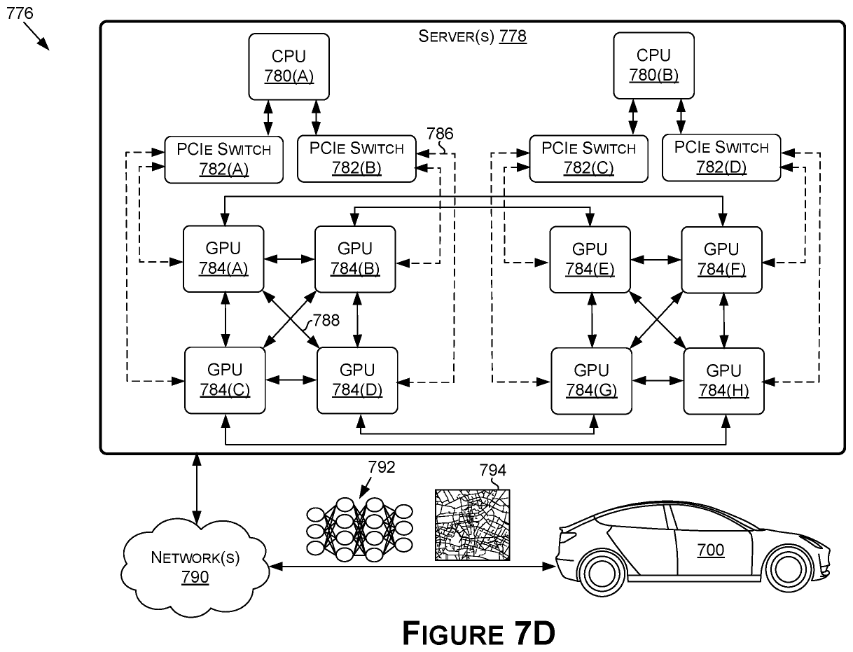

Systems and methods are disclosed for sorting measurements from multiple sensors into an order that is based on detection times associated with the measurements and submitting the measurements to a sensor fusion system in the sorted order without dropping a substantial number of measurements, even if the measurements received from the sensors are out of order across sensors. Although the present disclosure may be described with respect to an example autonomous or semi-autonomous vehicle or machine 700 (alternatively referred to herein as “vehicle 700” or “ego-machine 700,” an example of which is described with respect to FIGS. 7A-5D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to monitoring sensor performance in autonomous and/or semi-autonomous vehicles, this is not intended to be limiting, and the systems and methods described herein may be used in augmented reality, virtual reality, mixed reality, robotics, security and surveillance, autonomous or semi-autonomous machine applications, and/or any other technology spaces where sensor monitoring may be used.

To improve the sorting of sensor measurements, the disclosed techniques introduce a time-window based sensor measurement scheduling engine that determines an ordering of measurements received from multiple sensors in which the measurements are sorted by detection time, and submits the measurements in the sorted order to a sensor fusion system. Upon receiving the measurements from the sensors, the scheduling engine determines a current time window that includes camera measurements received since the most recent submission of a previous camera measurement to the sensor fusion system. The determined current time window includes camera measurements since the timestamp of the most recent submission because any measurements older than the most recent submission are out of date and could cause inconsistent state if used. The scheduling engine determines an upper boundary of the current time window based on a timestamp of the most recent camera measurement. Thus, the current time window includes the camera measurements that are candidates for submission to the fusion system. Measurements from other sensors may be outside the current time window. Any measurements from other sensors, such as RADAR, that are less than a threshold amount of time ahead of or behind the current time window can be extrapolated to a time in the current time window for comparison with the camera measurements in the current time window. The current time window is sized to correspond to the camera because extrapolation of camera measurements is less accurate than extrapolation of RADAR measurements. Although camera and RADAR sensors are described in the examples herein, other sensors may be used instead of or in addition to cameras and/or RADAR-such as LiDAR, ultrasonic, etc. Thus, the current time window is sized to include measurements that are available from the sensor having the lowest extrapolation accuracy. Measurements from other sensors having higher extrapolation accuracy can be extrapolated into the current time window. The scheduling engine uses the sensor detection times associated with the measurements in the determination of the boundaries of the current time window and also in comparisons between measurements, so the measurement ordering determined by the scheduling engine is based on detection times of the measurements.

The scheduling engine selects the latest sensor measurement in a time range for each sensor type. For example, if the measurements are from cameras and RADAR sensors as described above, then the scheduling engine selects the latest camera measurement and the latest RADAR measurement. Since the current time window is sized to include the available camera measurements, the scheduling engine selects the latest camera measurement from the current time window. There may be RADAR measurements outside the current time window, and the scheduling engine selects a latest RADAR measurement that is in the current time window or within a threshold amount of time ahead of or behind the current time window. If the latest RADAR measurement is ahead of or behind the current time window (by less than the threshold amount of time), then the scheduling engine extrapolates the latest RADAR measurement to determine a predicted RADAR measurement that is in the current time window. The extrapolation enables the scheduling engine to compare measurements having timestamps outside the time window to measurements having timestamps in the time window. The scheduling engine then sorts the selected measurements based on their timestamps in the current time window, which are the timestamps of the extrapolated measurements for measurements that were extrapolated. The scheduling engine submits the selected measurements to the fusion system in the sorted order. Since the scheduling engine selects a sensor measurement for each sensor type prior to submitting the measurements to the fusion system for processing, measurements of a given sensor type are not dropped for being older than measurements of other sensor types that have already been processed. The use of the current time window enables the disclosed techniques to accommodate a wider range of input timestamps than in other approaches that use the fusion system cycle to bound the measurements for sorting.

One technical advantage of the disclosed techniques relative to the prior solutions is the ability to accurately track objects using input from multiple sensors that generate measurements at different and/or varying rates. Prior approaches do not process measurements from multiple sensors in order of detection times if the measurements are out of order across sensors, as can occur when sensors generate measurements at different and/or varying rates. Further, prior approaches can drop a substantial number of measurements in certain timing scenarios, thereby reducing object tracking accuracy. The disclosed scheduling engine uses a time window for measurements and thus can accommodate a wider range of input timestamps. The scheduling engine correctly sorts the measurements received from multiple sensors into an order based on detection times of the measurements, even if the measurements are received at different rates, out of order across sensors, and/or out of order across cycles. Thus, measurements across the wider range of timestamps can be sorted or extrapolated to align with the resulting processing schedule.

Another technical advantage of the disclosed techniques is that the disclosed scheduling engine does not use or allocate additional memory to buffer or otherwise store measurements. Instead, the scheduling engine receives measurements, sorts the measurements, and provides the measurements to a sensor fusion system during a fusion cycle, without allocating additional memory buffers in which to store the measurements. Accordingly, the disclosed techniques are faster and less resource-intensive than prior approaches that use memory to temporarily store, e.g., buffer, measurements prior to sorting and providing the measurements to a sensor fusion system. Another technical advantage of the disclosed techniques is the ability to perform accurate object tracking because measurements from multiple sensors are dropped less frequently than in prior approaches. Dropping fewer measurements results in improved accuracy of sensor input processing and object tracking in autonomous or semi-autonomous systems.

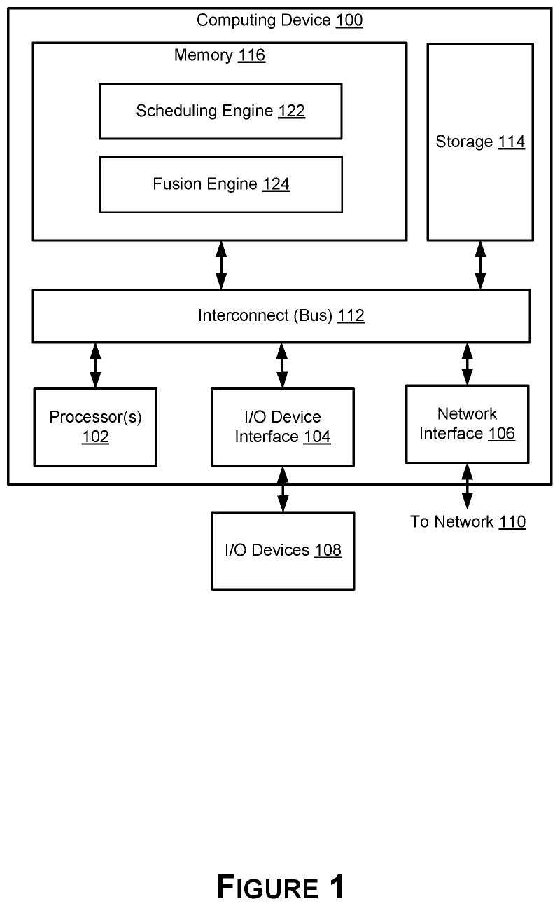

FIG. 1 illustrates a computing device 100 configured to implement one or more aspects of various embodiments. In at least one embodiment, computing device 100 includes a desktop computer, a laptop computer, a smart phone, a personal digital assistant (PDA), a tablet computer, a server, one or more virtual machines, an embedded system, a system on a chip, a computing system of an autonomous, semi-autonomous, or a non-autonomous machine, and/or any other type of computing device configured to receive input, process data, and optionally display information, and is suitable for practicing one or more embodiments. Computing device 100 is configured to run a scheduling engine 122 and a sensor fusion engine 124 that may reside in a memory 116. It is noted that the computing device described herein is illustrative and that any other technically feasible configurations fall within the scope of the present disclosure. For example, multiple instances of scheduling engine 122 and/or sensor fusion engine 124 may execute on a set of nodes in a distributed and/or cloud computing system to implement the functionality of computing device 100. Alternatively, computing device 100 may be implemented similar to that of the computing device of the example autonomous or semi-autonomous machine 500 described at least with respect to FIGS. 7A-7D.

In at least one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and/or a network interface 106. Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing device 100 may correspond to a physical computing system (e.g., a system in a data center or a machine) and/or may correspond to a virtual computing instance executing within a computing cloud.

In at least one embodiment, I/O devices 108 include devices capable of receiving input, such as a keyboard, a mouse, a touchpad, a VR/MR/AR headset, a gesture recognition system, a steering wheel, mechanical, digital, or touch sensitive buttons or input components, and/or a microphone, as well as devices capable of providing output, such as a display device, haptic device, and/or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In at least one embodiment, network 110 is any technically feasible type of communications network that allows data to be exchanged between computing device 100 and internal, local, remote, or external entities or devices, such as a web server or another networked computing device. For example, network 110 may include a wide area network (WAN), a local area network (LAN), a wireless (e.g., WiFi) network, a cellular network, and/or the Internet, among others.

In at least one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Scheduling engine 122 and/or sensor fusion engine 124 may be stored in storage 114 and loaded into memory 116 when executed.

In one embodiment, memory 116 includes a random-access memory (RAM) module, a flash memory unit, and/or any other type of memory unit or combination thereof. Processor(s) 102, I/O device interface 104, and network interface 106 may be configured to read data from and write data to memory 116. Memory 116 may include various software programs or more generally software code that can be executed by processor(s) 102 and application data associated with said software programs, including scheduling engine 122 and/or sensor fusion engine 124.

Scheduling engine 122 includes functionality to determine an ordering of measurements received from multiple sensors in which the measurements are sorted by detection time, and submits the measurements in the sorted order to a sensor fusion system without dropping a substantial number of measurements. More specifically, scheduling engine 122 is configured to receive measurements from multiple sensors, determine an ordering of the measurements in which the measurements are sorted by detection time, and submit the measurements in the sorted order to the sensor fusion engine 124 without dropping a substantial number of measurements. Upon receiving the measurements from the sensors, the scheduling engine 122 determines a current time window that includes camera measurements received since the most recent submission of a previous camera measurement to the sensor fusion system. The scheduling engine 122 determines an upper boundary of the current time window based on a timestamp of the most recent camera measurement. The scheduling engine 122 selects the latest sensor measurement in a time range for each sensor type. There may be RADAR measurements outside the current time window, and the scheduling engine 122 selects a latest RADAR measurement that is in the current time window or within a threshold amount of time ahead of or behind the current time window. If the latest RADAR measurement is ahead of or behind the current time window (by less than the threshold amount of time), then the scheduling engine 122 extrapolates the latest RADAR measurement to determine a predicted RADAR measurement that is based on a time in the current time window. The scheduling engine 122 then sorts the selected measurements based on their timestamps in the current time window, which are the timestamps of the extrapolated measurements for measurements that were extrapolated. The scheduling engine 122 submits the selected measurements to the sensor fusion engine 124 in the sorted order.

Sensor fusion engine 124 includes functionality to perform three-dimensional (3D) sensor fusion operations that determine which input objects received from different cameras represent the same physical object, and output an output object for each physical object. The outputted object have characteristics, such as position, velocity, acceleration, and/or orientation, based on a combination of two or more input objects that represent the same physical object from two or more sensors.

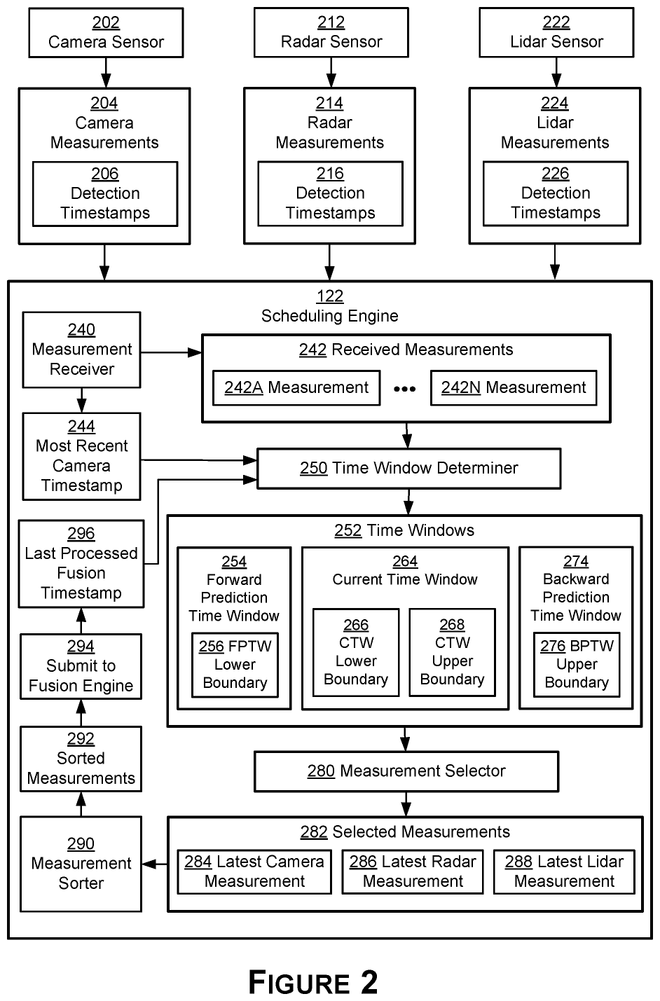

FIG. 2 is a more detailed illustration of the scheduling engine of FIG. 1, according to various embodiments. As mentioned herein, scheduling engine 122 operates to determine sorted measurements 292, which include an ordering of measurements 204, 214, 224 in which the measurements are sorted by detection time, and to submit the measurements in the sorted order to a sensor fusion engine 124 without dropping a substantial number of measurements.

The sensor measurement scheduling engine 122 repeatedly performs a scheduling operation. Each invocation of the scheduling operation is referred to herein as an iteration of the scheduling engine 122. The scheduling operation receives a set of one or more measurements from one or more sensors and determines a current time window 264, which may include a time range having a lower boundary 266 and an upper boundary 268. The boundaries of the current time window 264 are determined such that the current time window 264 includes camera measurements received since the most recent submission of a previous camera measurement to the sensor fusion engine 124. The scheduling engine 122 selects a latest measurement 282 for each type of sensor (RADAR, LiDAR, ultrasonic, etc.) based on the current time window 264, sorts the selected latest measurements 282, and submits the sorted latest measurements 292 to the sensor fusion engine 124. The selected measurements 282 may include a latest camera measurement 284, a latest RADAR measurement 286, and/or a latest LiDAR measurement 288. The scheduling engine 122 may perform the scheduling operation at a given frequency or in response to a threshold criterion being satisfied. For example, the frequency may be every 1000 milliseconds, every 1500 milliseconds, or other suitable frequency. As another example, the scheduling engine 122 may perform the scheduling operation in response to a threshold condition such as a threshold number of measurements being received. The threshold number of measurements may be 10, 50, 100, or other suitable number of measurements.

In each iteration, a measurement receiver 240 of the scheduling engine 122 receives one or more measurements 204, 214, 224 associated with respective detection timestamps 206, 216, 226 from one or more respective sensors 202, 212, 222. The measurements received in a current iteration are shown as received measurements 242, which include one or more measurements, such as a measurement 242A and a measurement 242N. Received measurements 242 may also include measurements received in previous iterations but not submitted to the sensor fusion engine 124. Received measurements 242 may include measurements generated by one or more of the sensors 202, 212, 222 up until the time at which measurement receiver 240 is invoked in the current iteration.

As described herein, the current time window 264 is used to identify camera measurements. The scheduling engine 122 identifies two additional time windows: a backward prediction time window 274 (“BPTW”) and a forward prediction time window 254 (“FPTW”). The backward prediction time window 274 is used to identify recent RADAR measurements that may have occurred after the most recent camera measurement. If there is such a recent RADAR measurement, the scheduling engine extrapolates the measurement from the backward prediction time window 274 to the current time window 264. The backward prediction time window 274 follows the current time window and has a predetermined length which may be, e.g., between 200 and 400 milliseconds. Thus, the lower boundary of the backward prediction time window 274 corresponds to the upper boundary 268 of the current time window 264. The upper boundary 276 of the back prediction time window 274 can be specified by the upper boundary of the current time window 264 plus the predetermined length of the backward prediction time window 274.

The forward prediction time window 254 precedes the current time window 264 and has a predetermined length which may be, e.g., a length between 200 and 400 milliseconds. Thus, a lower boundary 256 of the forward prediction time window is specified by the lower boundary of the current time window 264 minus the length of the forward prediction time window 254. The upper boundary of the forward prediction time window 254 corresponds to the lower boundary 266 of the current time window 264.

A time window determiner 250 of the scheduling engine 122 determines time windows 252 based on a most recent camera timestamp 244 and a last processed fusion timestamp 296. The most recent camera timestamp 244 may be the greatest timestamp associated with one of the received measurements 242. The last processed fusion timestamp 296 may be the timestamp associated with a most recently submitted measurement. The most recently submitted measurement may be the received measurement 242 that was most recently submitted to the sensor fusion engine 124. The most recently submitted measurement may be the last measurement submitted in the previous iteration of the scheduling engine 122, for example.

Each of the time windows 252 has a lower boundary and an upper boundary. A timestamp is in a time window if the timestamp is greater than or equal to the lower boundary and less than or equal to the upper boundary of the time window. Thus, a time window is determined by determining the lower and upper boundaries of the time window. The current time window 264 determined by the scheduling engine 122 has a lower boundary 266 specified by the last processed fusion timestamp 296 and an upper boundary 268 specified by the most recent camera timestamp 244. According to these boundaries, the current time window 264 includes the timestamp of each camera measurement in received measurements 242.

The time window determiner 250 also determines a forward prediction time window 254, which has an upper boundary corresponding to the current time window (CTW) lower boundary 266 and a FPTW lower boundary 256 determined by subtracting a predetermined amount of time from the CTW lower boundary 266. Thus, the forward prediction time window 254 may include the time stamp of each measurement 242 having a timestamp greater than or equal to the FPTW lower boundary 256 and less than the current time window 264.

The time window determiner 250 also determines a backward prediction time window 274, which has a lower boundary corresponding to CTW upper boundary 268 and an upper boundary 276 determined by adding a predetermined amount of time to the CTW upper boundary 268. Thus, the forward prediction time window 254 includes the time stamp of each measurement 242 having a timestamp greater than the CTW upper boundary 268 and less than or equal to the BPTW upper boundary 276. The predetermined amount of time may be, e.g., 200 milliseconds, 400 milliseconds, 750 milliseconds, or other suitable value. Different predetermined amounts of time may be used for the forward and backward prediction time windows. For example, the predetermined amount of time used for the backward prediction time window may be greater than that used for the forward prediction time window, and may be sufficiently large to cause the backward prediction time window to extend to the current time at which the current iteration is being performed.

A measurement selector 280 of the scheduling engine 122 selects the latest camera measurement in the current time window 264 and selects the latest RADAR measurement in the backward prediction time window 274, current time window 264, or forward prediction time window 254, in that order. The “latest” measurement is identified according to the detection timestamp associated with the measurement. Thus, the latest measurement in the current time window 264 is the measurement 242 having the greatest timestamp that is between the CTW lower boundary 266 and the CTW upper boundary 268.

The scheduling engine 122 selects a set of measurements that includes measurements made by the camera in the current time window and further includes the most recent available measurements made by other sensors, such as RADAR, during the current time window, a previous time window, or a subsequent time window, in that order (in non-limiting embodiments). If any of the most recent available measurements made by the other sensors have detection times outside the current time window, then the scheduling engine 122 extrapolates those measurements into the current time window. The scheduling engine 122 sorts the selected measurements by their respective time stamps and submits the selected measurements to the fusion system in the sorted order. The lower and upper boundaries of the current time window are determined based on camera measurement parameters, so that the current time window includes the camera measurements.

Since extrapolation is less accurate for camera measurements than for other types of sensors such as RADAR, the lower and upper boundaries of the current time window are determined so that the window includes the camera measurements for the current fusion cycle with no need for extrapolation. Measurements from other types of sensors are extrapolated forward or backward in time to the current time window. The other types of sensors, which may include RADAR, perform extrapolation more accurately than cameras. In other examples, any sensor type that has the lowest extrapolation accuracy of the sensors in use may be selected as the basis for determining the current time window.

To select the latest RADAR measurement in the backward prediction time window 274, current time window 264, or forward prediction time window 254, measurement selector 280 determines whether there is at least one RADAR measurement in the received measurements 242 having a timestamp that is in the backward prediction time window 274. If so, the measurement selector 280 selects the latest RADAR measurement in the backward prediction time window 274 and extrapolates the latest RADAR measurement to the current time window 264. The extrapolation determines predicted values that are in the current time window 264 and can be compared to other measurements in the current time window 264. The measurement selector 280 performs the extrapolation of measurement characteristics, such as the position, velocity, and/or acceleration of the measured object, over an amount of time that corresponds to the time difference between the time of the measurement and the time to which the measurement is extrapolated. The position, velocity, and/or acceleration of the object at its measured position can be used as initial values, and the extrapolated position, velocity, and/or acceleration can be determined from the initial values and the time difference using suitable prediction techniques. The prediction techniques may include analytical and/or deep learning approaches. Analytical approaches may use suitable kinematic equations and/or heuristics. Deep learning approaches may use deep neural networks. Predictions may be from a later time to an earlier time, as in the case of generated a predicted measurement in the current time window 264 based on a measurement in the backward prediction time window 274 (“backward prediction”). Predictions may also be from an earlier time to a later time, as in the case of generating a predicted measurement in the current time window 264 based on a measurement in the forward prediction time window 274 (“forward prediction”).

If a RADAR measurement is not present in the backward prediction time window 274, then the measurement selector 280 determines whether there is at least one RADAR measurement in the received measurements 242 having a timestamp that is the current time window 264. If so, the measurement selector 280 selects the latest RADAR measurement in the current time window 264. Extrapolation need not be performed because the latest timestamp is already in the current time window 264.

Otherwise, if a RADAR measurement is not present in the current time window 264, then the measurement selector 280 determines whether there is at least one RADAR measurement in the received measurements 242 having a timestamp that is in the forward prediction time window 254. If so, the measurement selector 280 selects the latest RADAR measurement in the forward prediction time window 254 and extrapolates the latest RADAR measurement to the current time window 264. Otherwise, there are no RADAR measurements in the received measurements 242 in any of the time windows 252, and the measurement selector 280 does not select a RADAR measurement. The measurement selector 280 may generate a log entry or other indication specifying the latest RADAR timestamp in the received measurements 242 and indicating that a RADAR timestamp was not selected.

The received measurements 242 may include other types of measurements in addition to or instead of the camera and RADAR measurements examples described herein. Another type of measurement may be LiDAR measurements, for example. For each type of measurement, the measurement selector 280 may treat the type of measurement similarly to either the camera measurements or the RADAR measurements described herein. If a given type of measurement has characteristics similar to camera measurements, e.g., LiDAR measurements are generated at approximately the same times and rates as camera measurements, then the given type of measurement can be treated similarly to camera measurements. Since LiDAR measurements are generated at approximately the same time and rates as camera measurements, LiDAR measurements can be selected from the current time window 264 similarly to camera measurements. A type of sensor that is not similar to cameras is suitable for accurate extrapolation can be treated similarly to RADAR as described herein.

The scheduling engine 122 invokes a measurement sorter 290, which sorts the selected measurements 282 into order of increasing detection time. For measurements that were extrapolated, the timestamp associated with predicted measurement is used. The scheduling engine 122 then invokes a submission component 294 that submits the sorted measurements 292 to the sensor fusion engine 124 and updates the last processed fusion timestamp 296 to have the value of the timestamp associated with the measurement most recently submitted to the sensor fusion engine 124.

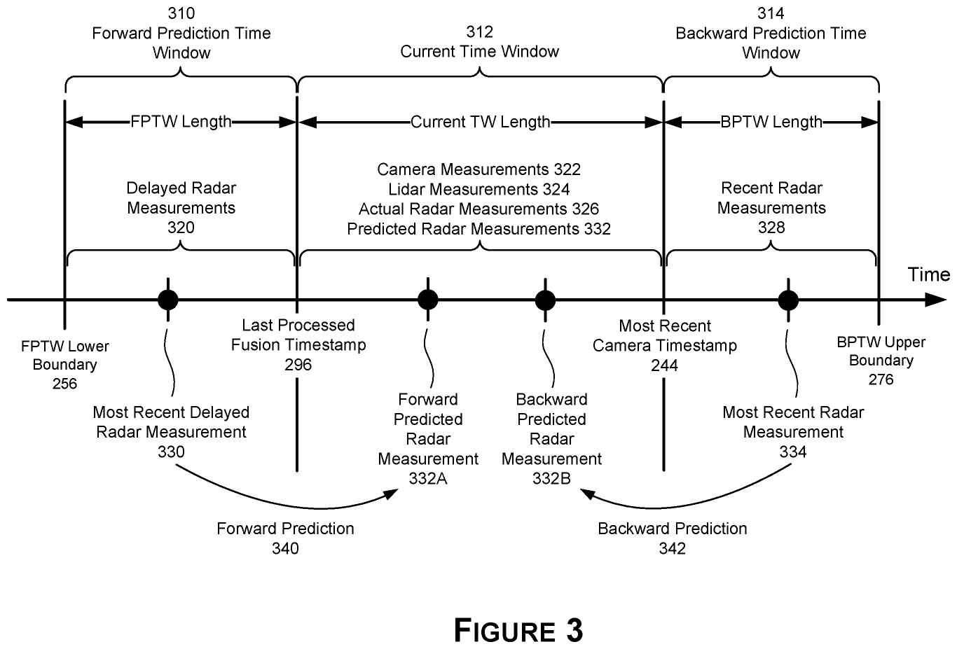

FIG. 3 illustrates a current time window 312, a forward prediction time window 310, and a backward prediction time window 314, according to various embodiments. The current time window 312 has a lower boundary specified by a last processed fusion timestamp 296 and an upper boundary specified by a most recent camera timestamp 244. The current time window 312 can include camera measurements 322, LiDAR measurements 324, actual (e.g., non-predicted) RADAR measurements 326, and/or predicted RADAR measurements 332. The backward prediction time window 314 has a lower boundary specified by the most recent camera timestamp 244 and an upper boundary 276 specified by adding a predetermined time length to the most recent camera timestamp 244. The forward prediction time window 310 may include delayed RADAR measurements 320 having timestamps older than the timestamps of actual RADAR measurements 326 in the current time window 312. The backward prediction time window 314 may include recent RADAR measurements 328 that have timestamps newer than the actual RADAR measurements 326 in the current time window 312 (and also newer than delayed RADAR measurements 320 in the forward prediction time window 310).

A backward prediction 342 is illustrated as an arrow from a most recent RADAR measurement 334 in the backward prediction time window 314 to a backward predicted RADAR measurement 332B in the current time window 312. The backward prediction can be an interpolation operation that determines a time difference between the most recent RADAR measurement 334 and a target time in the current time window 312, such as the most recent time in the current time window 312 that is less than the most recent camera timestamp 244. The interpolation operation computes the spatial and motion characteristics of the predicted RADAR measurements 332A using suitable kinematics equations based on the characteristics of the most recent RADAR measurement 334 and the time difference.

A forward prediction 340 is illustrated as an arrow from a most recent delayed RADAR measurement 330 in the forward prediction time window 310 to a forward predicted RADAR measurement 332A in the current time window 312. The forward predicted RADAR measurement 332A has an associated timestamp in the current time window 312, but the associated timestamp is determined by the scheduling engine 122 by selecting a time in the current time window 312. Thus, the associated timestamp of the forward predicted RADAR measurement 332A indicates a time associated with the predicted measurement 332A instead of a time at which a detection occurred. The backward predicted RADAR measurement 332B has an associated timestamp similarly determined by the scheduling engine 122 instead of by a sensor detection.

Similarly to the backward prediction 342, the forward prediction 340 can be an interpolation operation that determines a time difference between the most recent delayed RADAR measurement 330 and a target time in the current time window 312, such as the earliest time in the current time window 312 that is greater than or equal to the last processed fusion timestamp 296 (so that the amount of change in the interpolation is minimized). The interpolation operation computes the spatial and motion characteristics of the predicted RADAR measurements 332A using suitable kinematics equations based on the characteristics of the most recent delayed RADAR measurement 330 and the time difference.

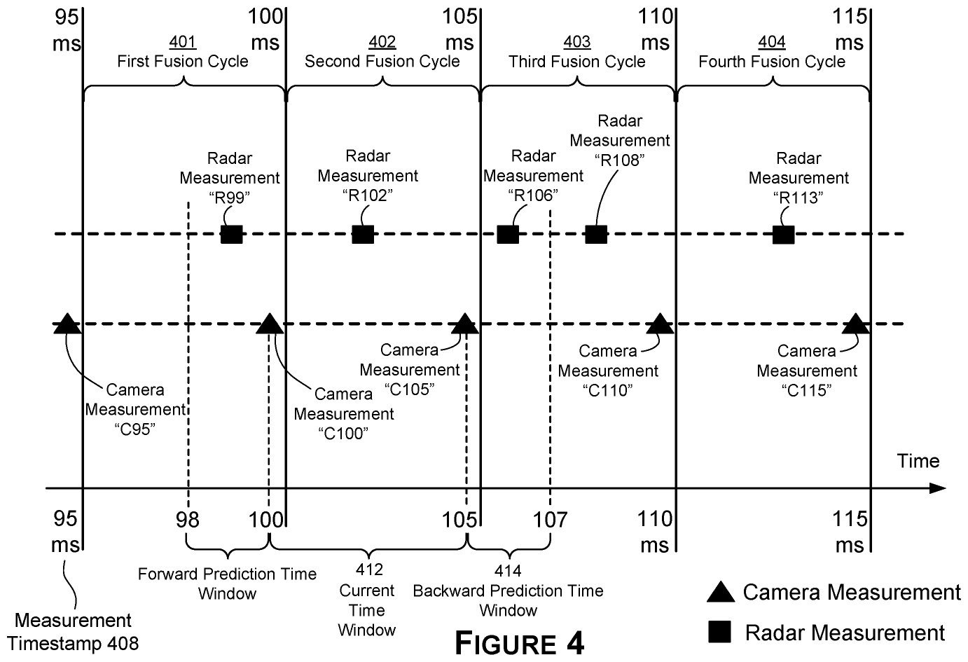

FIG. 4 illustrates example RADAR measurements that arrive at a scheduling engine 122 at different rates than camera measurements, according to various embodiments. Each RADAR measurement is shown as a square, and each camera measurement is shown as a triangle. Each measurement has an associated measurement timestamp 408, which represents the detection time of the measurement. The sensor fusion engine 124 operates at according to a periodic fusion cycle. A camera measurement occurs near the end of each fusion cycle, but the RADAR measurements occur at random times. In the example shown, a RADAR measurement R99 and a camera measurement C100, which arrive in a first fusion cycle 401, are processed in a first iteration of the scheduling engine 122. The first iteration is not shown in detail.

A RADAR measurement R102 and a camera measurement C105 arrive in a second fusion cycle 402 and are processed in a second iteration of the scheduling engine 122 which uses a current time window 412. In the third fusion cycle 403, two RADAR measurements (RADAR measurement R106 and RADAR measurement R108) arrive in the same cycle, along with a camera measurement C110. Other approaches that process each cycle independently and sort the measurements within each cycle would submit RADAR measurement R106 and camera measurement C110 to the sensor fusion engine 124 in the third fusion cycle 403, but would be unable to process RADAR measurement R108 in the fourth fusion cycle 404 because a newer measurement (camera measurement C110) has already been submitted in the third fusion cycle 403. Other approaches would drop RADAR measurement R108 because it is older than the last processed measurement C110, and not submit a RADAR measurement in the third fusion cycle 403. This pattern can continue in subsequent cycles. For example, in a fifth cycle (not shown), other approaches would drop RADAR measurement R113 and not submit a RADAR measurement to the sensor fusion engine 124.

Using the scheduling engine 122 described herein, the RADAR measurement R106 is identified as being in a backward prediction time window 414 in a second scheduling engine iteration. The RADAR measurement R106 is backward-predicted to a current time window 412, and the backward-predicted RADAR measurement is submitted to the sensor fusion engine 124 with the camera measurement C105 because the backward-predicted RADAR measurement is more recent than the RADAR measurement R102, which is not selected by the measurement selector. Although the RADAR measurement R102 is dropped by the scheduling engine, the next iteration successfully identifies and submits a RADAR measurement R108 with the camera measurement C110. A subsequent iteration again successfully identifies and submits RADAR measurement R113 with camera measurement C115. Thus, the scheduling engine 122 drops one measurement and continues to submit RADAR measurements in subsequent iterations, instead of dropping multiple measurements from the third fusion cycle 403 onward, as in other approaches.

FIG. 5 illustrates an example execution of a scheduling engine 122 for RADAR and camera measurements that arrive at different rates, according to various embodiments. A table 500 lists the state of the scheduling engine 122 at each iteration of the first four iterations performed on the measurements shown in FIG. 4. For each iteration, the table 500 shows the iteration number 502, input measurements 504, last processed fusion timestamp 506, most recent camera timestamp 508, time windows 510 (lower boundary 512 and upper boundary 514), selected latest camera measurement 516, selected latest RADAR measurement 518, back-predicted RADAR measurement 520 (if back prediction is performed), and sorted measurements 540.

In the first iteration, for which a time window is not shown in FIG. 4, the input measurements are a RADAR measurement R99, a camera measurement C110, and a RADAR measurement R102. The last processed fusion timestamp 506 is C95, and the most recent camera timestamp 508 is C100. The current time window has a lower boundary at time T=95 and an upper boundary at T=100 ms. The forward prediction time window has a lower boundary at t=95−2-93 ms, where 2 is the predetermined length of the forward prediction time window. The backward prediction time window has an upper boundary of 100+2=102 ms. The selected latest camera measurement is C100, which is the camera measurement having the highest timestamp in the current time window 264 (not shown in FIG. 4). The selected latest RADAR measurement 518 is R99, which is in the current time window 264 and there is no back-predicted RADAR measurement because no RADAR measurements are in the backward prediction time window in the first iteration. The resulting selected measurements are C100 and R99, and the sorted measurements are R99, C100 (since the timestamp of C99 (99) is less than the timestamp of C100 (100)).

In the second iteration, for which a current time window 412 is shown in FIG. 4, the input measurements are a RADAR measurement R102, a camera measurement C105, and a RADAR measurement R106. The last processed fusion timestamp 506 is C100 (submitted to the sensor fusion engine 124 in the previous iteration), and the most recent camera timestamp 508 is C105. The current time window has a lower boundary at time T=100 and an upper boundary at T=105 ms. The forward prediction time window has a lower boundary at t=100-2-96 ms, where 2 is the predetermined length of the forward prediction time window. The backward prediction time window has an upper boundary of 105+2=107 ms. The selected latest camera measurement is C105, which is the camera measurement having the highest timestamp in the current time window 264. The selected latest RADAR measurement 518 is R106, which is in the backward prediction time window 414 as shown in FIG. 4. The back-predicted RADAR measurement 520 in the current time window 412 is R105. The resulting selected measurements are C105 and R105, and the sorted measurements are C105, R105. Although the scheduling engine 122 has dropped RADAR measurement R102, a RADAR measurement (R105, back-predicted from R106) has been submitted to the sensor fusion engine 124, and no further RADAR measurements will be dropped in the next two iterations.

In the third iteration, for which a time window is not shown in FIG. 4, the input measurements are a RADAR measurement R108, a camera measurement C110, and a RADAR measurement R113. The last processed fusion timestamp 506 is C105, and the most recent camera timestamp 508 is C110. The current time window has a lower boundary at time T=105 and an upper boundary at T=110 ms. The forward prediction time window has a lower boundary at t=105−2=103 ms. The backward prediction time window has an upper boundary of 110+2=112 ms. The selected latest camera measurement is C110, which is the camera measurement having the highest timestamp in the current time window 264 (not shown in FIG. 4). The selected latest RADAR measurement 518 is R108, which is in the current time window 264 and there is no back-predicted RADAR measurement because no RADAR measurements are in the backward prediction time window in the third iteration. The resulting selected measurements are R108 and C110, and the sorted measurements are R108, C110.

In the fourth iteration, for which a time window is not shown in FIG. 4, the input measurements are a RADAR measurement R113 and a camera measurement C115. The last processed fusion timestamp 506 is C110, and the most recent camera timestamp 508 is C115. The current time window has a lower boundary at time T=110 and an upper boundary at T=115 ms. The forward prediction time window has a lower boundary at t=110−2=108 ms. The backward prediction time window has an upper boundary of 115+2=117 ms. The selected latest camera measurement is C115, which is the camera measurement having the highest timestamp in the current time window 264 (not shown in FIG. 4). The selected latest RADAR measurement 518 is R113, which is in the current time window 264 and there is no back-predicted RADAR measurement because no RADAR measurements are in the backward prediction time window in the fourth iteration. The resulting selected measurements are R113 and C115, and the sorted measurements are R113, C110.

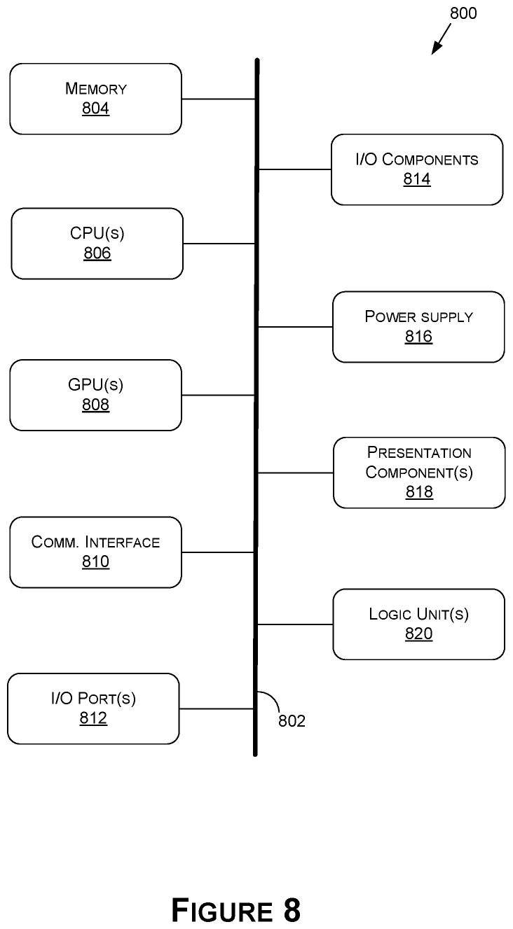

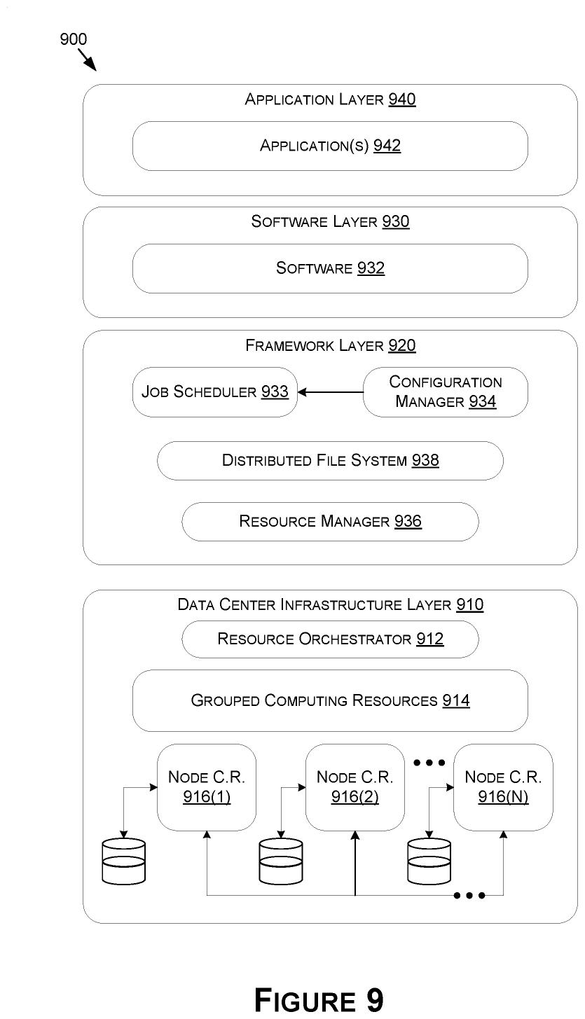

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 500 of FIGS. 7A-7D, example computing device 800 of FIG. 8, and/or example data center 900 of FIG. 9.

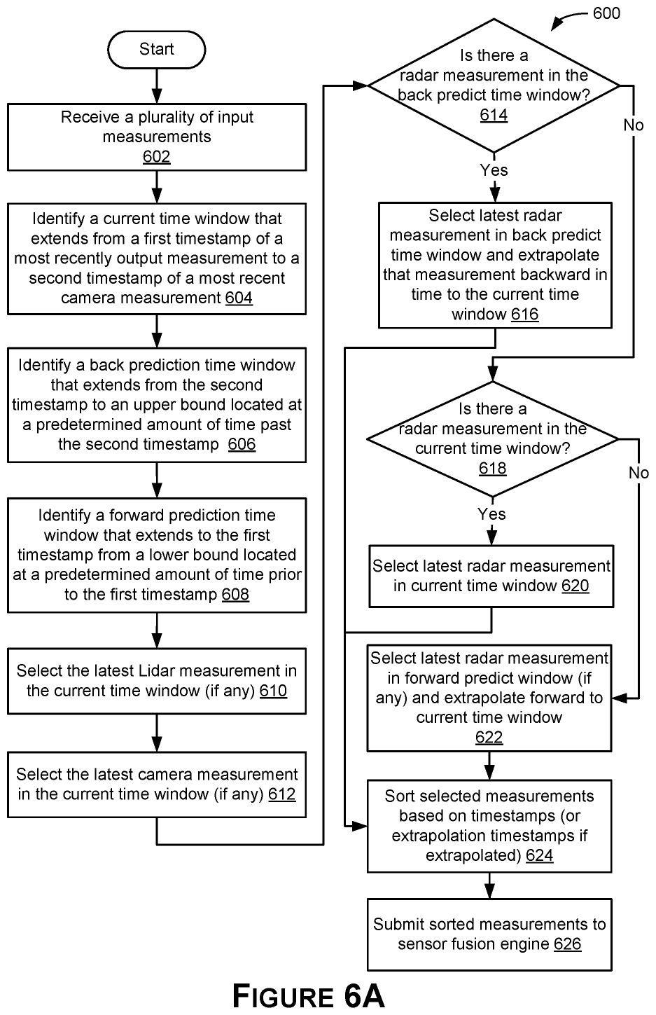

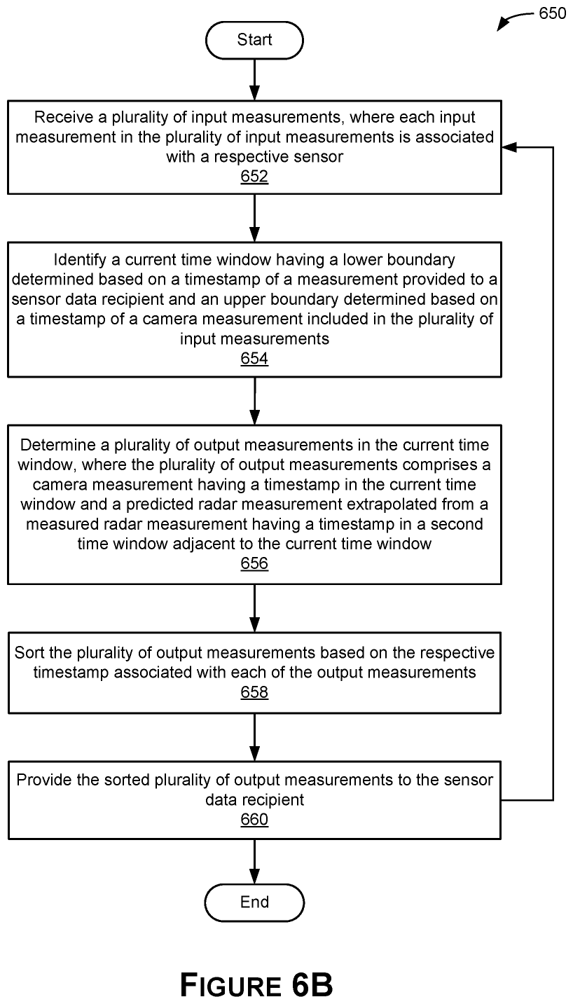

Now referring to FIG. 6A, each block of method 600, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 600 is described, by way of example, with respect to the system of FIGS. 1-2. However, this method may additionally or alternatively be executed by any one system, or any combination of systems, including, but not limited to, those described herein. Further, the operations in method 600 can be omitted, repeated, and/or performed in any order without departing from the scope of the present disclosure.

FIG. 6A illustrates a flow diagram of a method 600 for sorting a set of sensor measurements based on sorted order of measurements from three types of sensors, according to various embodiments. As shown in FIG. 6, method 600 begins with operation 602, in which scheduling engine 122 receives a plurality of input measurements 242. Each input measurement 242 is associated with a respective sensor 202, 212, or 222. For example, each input measurement 242 can be received from a sensor 202 that detected an object, and the input measurement can include data generated by the sensor 202 in response to the detection.

In operation 604, scheduling engine 122 identifies a current time window 264 that extends from a first timestamp of a most recently output measurement (e.g., a most recently output one of the sorted measurements 292) to a second timestamp of a most recent camera measurement 604. The first timestamp can be the CWT lower boundary 266, and the second timestamp can be the CWT upper boundary 268.

In operation 606, scheduling engine 122 identifies a back prediction time window 274 that extends from the second timestamp to an upper bound located at a predetermined amount of time past the second timestamp. The upper bound can be the BPTW upper boundary 276. The amount of time past the second timestamp may be a BPTW length shown in FIG. 3.

In operation 608, scheduling engine 122 identifies a forward prediction time window 254 that extends to the first timestamp from a lower bound located at a predetermined amount of time prior to the first timestamp. The lower bound can be the FPTW lower boundary 256. The amount of time prior to the first timestamp can be the FPTW length shown in FIG. 3.

In operation 610, scheduling engine 122 selects the latest LiDAR measurement 324 in the current time window 264 (if any). In operation 612, scheduling engine 122 selects the latest camera measurement 322 in the current time window 264 (if any). Scheduling engine 122 selects the latest LiDAR and camera measurements in the current time window 264 in the example of FIG. 6A because the LiDAR and camera sensors have similar characteristics, e.g., generate measurements at similar times in this example.

In operation 614, scheduling engine 122 determines whether there is an actual RADAR measurement in the backward prediction time window 274. The term “actual RADAR measurement” as used herein refers to a RADAR measurement received from a sensor. The term “predicted RADAR measurement” as used herein refers to a RADAR measurement predicted from an actual RADAR measurement, e.g., by extrapolation. There is a RADAR measurement in the backward prediction time window 274 if, for example, there is a RADAR measurement having a timestamp between the lower and upper boundaries of the backward prediction time window 274. If there is a RADAR measurement in the backward prediction time window 274, then scheduling engine 122 performs operation 616, in which scheduling engine 122 selects the latest RADAR measurement in the backward prediction time window 274 and extrapolates the measurement backward in time to the current time window 264. If there is not a RADAR measurement in the backward prediction time window 274, scheduling engine 122 performs operation 618, in which scheduling engine 122 determines whether there is a RADAR measurement in the current time window 264.

In operation 616, to extrapolate the measurement backward in time, scheduling engine 122 predicts the values that a measurement at a particular time in the current time window 264 would have been based on the values the RADAR measurement in the backward prediction time window 274. The result is a predicted RADAR measurement 332 in the current time window 264. The predicted values may include position, velocity, acceleration, and/or orientation, for example. As an example, the particular time in the current time window 264 may be the upper or lower boundary of the current time window 264, whichever is closer to the time associated with the RADAR measurement (e.g., to minimize the amount of time over which the prediction is made). As another example, the particular time in the current time window 264 may be the time of an existing measurement in the current time window 264, such as the most recent or earliest existing measurement in the current time window 264. As still another example, the particular time in the current time window 264 may be a midpoint between the upper and lower boundaries of the current time window 264. The scheduling engine 122 may select the existing measurement in the current time window 264 that is closest to the time associated with the RADAR measurement, for example. Subsequent to performing operation 616, scheduling engine 122 performs operation 624, in which scheduling engine 122 sorts the selected measurements 282 based on their associated timestamps or extrapolation timestamps if the selected measurements were extrapolated from a different time window into the current time window 264.

In operation 618, scheduling engine 122 determines whether there is an actual RADAR measurement 326 in the current time window. There is an actual RADAR measurement 326 in the current time window if, for example, there is an actual RADAR measurement 326 having a timestamp between the lower and upper boundaries of the current time window 264. If there is an actual RADAR measurement in the current time window, scheduling engine 122 performs operation 620, in which scheduling engine 122 selects the latest (actual) RADAR measurement in the current time window 264. Scheduling engine 122 need not extrapolate the latest RADAR measurement at operation 620, since the latest RADAR measurement is already in the current time window 264. If there is not an actual RADAR measurement in the current time window 264, scheduling engine 122 performs operation 622, in which scheduling engine 122 determines whether there is an actual RADAR measurement in the forward prediction time window 254. If so, at operation 622, scheduling engine 122 selects the latest (actual) RADAR measurement in the forward prediction time window 254 and extrapolates the latest RADAR measurement in the forward prediction time window 254 forward in time to the current time window 264. The result is a predicted RADAR measurement 332 in the current time window 264.

In operation 622, to extrapolate the measurement backward in time, scheduling engine 122 predicts the values that a measurement at a particular time in the current time window 264 would have been based on the values the RADAR measurement in the back-predicted time window. The values may include position, velocity, acceleration, and/or orientation, for example. As an example, the particular time in the current time window 264 may be the upper or lower boundary of the current time window 264, whichever is closer to the time associated with the RADAR measurement (to minimize the amount of time over which the prediction is mad). As another example, the particular time in the current time window 264 may be the time of an existing measurement in the current time window 264, such as the most recent or earliest existing measurement in the current time window 264. The scheduling engine 122 may select the existing measurement in the current time window 264 that is closest to the time associated with the RADAR measurement, for example. Subsequent to performing operation 616, scheduling engine 122 performs operation 624, in which scheduling engine 122 sorts the selected measurements based on their associated timestamps or extrapolation timestamps if the selected measurements were extrapolated from a different time window into the current time window 264. In operation 626, scheduling engine 122 submits the sorted measurements to sensor fusion engine 124. Scheduling engine 122 may repeat operations 602-626 periodically or in response to a threshold condition being satisfied. For example, scheduling engine 122 may repeat operations 602-626 at a predetermined frequency, such as every 1000 milliseconds, 1500 milliseconds, 2000 milliseconds, or other suitable frequency. As another example, scheduling engine 122 may repeat operations 602-626 in response to a threshold number of input measurements being available to receive, and/or in response to a threshold amount of time elapsing. Scheduling engine 122 may continue repeating operations 602-626 while sensor fusion engine 124 is in operation, for example.

Now referring to FIG. 6B, each block of method 650, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 600 is described, by way of example, with respect to the system of FIGS. 1-2. However, this method may additionally or alternatively be executed by any one system, or any combination of systems, including, but not limited to, those described herein. Further, the operations in method 650 can be omitted, repeated, and/or performed in any order without departing from the scope of the present disclosure.

FIG. 6B illustrates a flow diagram of a method 650 for scheduling delivery of sensor measurements to a sensor fusion engine, according to various embodiments. As shown in FIG. 6B, method 650 begins with operation 652, in which scheduling engine 122 receives a plurality of input measurements 242, where each input measurement in the plurality of input measurements is associated with a respective sensor 202, 212, or 222. The associated sensor may be, for example, a sensor from which the input measurement was received-which may include camera, LiDAR, RADAR, ultrasonic, etc.

In operation 654, scheduling engine 122 identifies a current time window 264 having a lower boundary determined based on a timestamp of a measurement provided to a sensor data recipient and an upper boundary determined based on a timestamp of a camera measurement included in the plurality of input measurements. The measurement provided to the sensor data recipient can be a most recent measurement provided to the sensor data recipient. The camera measurement included in the plurality of input measurements can be a most recent camera measurement included in the plurality of input measurements. The sensor data recipient can be sensor fusion engine 124 or some other downstream component that uses ordered sensor data, for example.

In operation 656, scheduling engine 122 determines a plurality of output measurements in the current time window 264, where the plurality of output measurements includes a camera measurement 322 having a timestamp in the current time window 264. The plurality of output measurements further includes a predicted RADAR measurement 332 in the current time window 264 extrapolated from an actual RADAR measurement having a timestamp in a second time window 254 or 274 adjacent to the current time window 264. The camera measurement having a timestamp in the current time window can be a most recent camera measurement having a timestamp in the current time window 264. The actual RADAR measurement 326 can be a most recent RADAR measurement having a timestamp in a second time window 254 or 274 adjacent to the current time window. The output measurements may be the selected measurements 282, for example.

In operation 658, scheduling engine 122 sorts the plurality of output measurements based on the respective timestamp associated with each of the output measurements. In operation 660, scheduling engine 122 provides the sorted plurality of output measurements to the sensor fusion engine 124. Scheduling engine 122 repeats operations 652-660 periodically or in response to a threshold condition being satisfied, e.g., as described herein with respect to the repetition of operations 602-626 FIG. 6A.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as large language models (LLMs) that process text, audio, and/or sensor data, systems for performing light transport simulation, systems for performing collaborative content creation for 3D assets, systems implemented at least partially using cloud computing resources, and/or other types of systems.

### Example Autonomous Vehicle

FIG. 7A is an illustration of an example autonomous vehicle 700, in accordance with some embodiments of the present disclosure. The autonomous vehicle 700 (alternatively referred to herein as the “vehicle 700”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 700 may be capable of functionality in accordance with one or more of Level 3-Level 7 of the autonomous driving levels. The vehicle 700 may be capable of functionality in accordance with one or more of Level 1-Level 7 of the autonomous driving levels. For example, the vehicle 700 may be capable of driver assistance (Level 1), partial automation (Level 2), conditional automation (Level 3), high automation (Level 4), and/or full automation (Level 7), depending on the embodiment. The term “autonomous,” as used herein, may include any and/or all types of autonomy for the vehicle 700 or other machine, such as being fully autonomous, being highly autonomous, being conditionally autonomous, being partially autonomous, providing assistive autonomy, being semi-autonomous, being primarily autonomous, or other designation.

The vehicle 700 may include components such as a chassis, a vehicle body, wheels (e.g., 2, 4, 6, 8, 18, etc.), tires, axles, and other components of a vehicle. The vehicle 700 may include a propulsion system 750, such as an internal combustion engine, hybrid electric power plant, an all-electric engine, and/or another propulsion system type. The propulsion system 750 may be connected to a drive train of the vehicle 700, which may include a transmission, to enable the propulsion of the vehicle 700. The propulsion system 750 may be controlled in response to receiving signals from the throttle/accelerator 752.

A steering system 754, which may include a steering wheel, may be used to steer the vehicle 700 (e.g., along a desired path or route) when the propulsion system 750 is operating (e.g., when the vehicle is in motion). The steering system 754 may receive signals from a steering actuator 756. The steering wheel may be optional for full automation (Level 7) functionality.

The brake sensor system 746 may be used to operate the vehicle brakes in response to receiving signals from the brake actuators 748 and/or brake sensors.

Controller(s) 736, which may include one or more system on chips (SoCs) 704 (FIG. 7C) and/or GPU(s), may provide signals (e.g., representative of commands) to one or more components and/or systems of the vehicle 700. For example, the controller(s) may send signals to operate the vehicle brakes via one or more brake actuators 748, to operate the steering system 754 via one or more steering actuators 756, to operate the propulsion system 750 via one or more throttle/accelerators 752. The controller(s) 736 may include one or more onboard (e.g., integrated) computing devices (e.g., supercomputers) that process sensor signals, and output operation commands (e.g., signals representing commands) to enable autonomous driving and/or to assist a human driver in driving the vehicle 700. The controller(s) 736 may include a first controller 736 for autonomous driving functions, a second controller 736 for functional safety functions, a third controller 736 for artificial intelligence functionality (e.g., computer vision), a fourth controller 736 for infotainment functionality, a fifth controller 736 for redundancy in emergency conditions, and/or other controllers. In some examples, a single controller 736 may handle two or more of the above functionalities, two or more controllers 736 may handle a single functionality, and/or any combination thereof.

The controller(s) 736 may provide the signals for controlling one or more components and/or systems of the vehicle 700 in response to sensor data received from one or more sensors (e.g., sensor inputs). The sensor data may be received from, for example and without limitation, global navigation satellite systems (“GNSS”) sensor(s) 758 (e.g., Global Positioning System sensor(s)), RADAR sensor(s) 760, ultrasonic sensor(s) 762, LiDAR sensor(s) 764, inertial measurement unit (IMU) sensor(s) 766 (e.g., accelerometer(s), gyroscope(s), magnetic compass(es), magnetometer(s), etc.), microphone(s) 796, stereo camera(s) 768, wide-view camera(s) 770 (e.g., fisheye cameras), infrared camera(s) 772, surround camera(s) 774 (e.g., 360 degree cameras), long-range and/or mid-range camera(s) 798, speed sensor(s) 744 (e.g., for measuring the speed of the vehicle 700), vibration sensor(s) 742, steering sensor(s) 740, brake sensor(s) (e.g., as part of the brake sensor system 746), and/or other sensor types. The controller(s) 736 may include one or more instances of scheduling engine 122 and/or sensor fusion engine 124 to monitor sensor performance based on the corresponding sensor data.

One or more of the controller(s) 736 may receive inputs (e.g., represented by input data) from an instrument cluster 732 of the vehicle 700 and provide outputs (e.g., represented by output data, display data, etc.) via a human-machine interface (HMI) display 734, an audible annunciator, a loudspeaker, and/or via other components of the vehicle 700. The outputs may include information such as vehicle velocity, speed, time, map data (e.g., the High Definition (“HD”) map 722 of FIG. 7C), location data (e.g., the vehicle's 700 location, such as on a map), direction, location of other vehicles (e.g., an occupancy grid), information about objects and status of objects as perceived by the controller(s) 736, etc. For example, the HMI display 734 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 700 further includes a network interface 724 which may use one or more wireless antenna(s) 726 and/or modem(s) to communicate over one or more networks. For example, the network interface 724 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 726 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 7B is an example of camera locations and fields of view for the example autonomous vehicle 700 of FIG. 7A, in accordance with some embodiments of the present disclosure. The cameras and respective fields of view are one example embodiment and are not intended to be limiting. For example, additional and/or alternative cameras may be included and/or the cameras may be located at different locations on the vehicle 700.

The camera types for the cameras may include, but are not limited to, digital cameras that may be adapted for use with the components and/or systems of the vehicle 700. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 700 (e.g., front-facing cameras) may be used for surround view, to help identify forward facing paths and obstacles, as well aid in, with the help of one or more controllers 736 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 770 that may be used to perceive objects coming into view from the periphery (e.g., pedestrians, crossing traffic or bicycles). Although only one wide-view camera is illustrated in FIG. 7B, there may be any number (including zero) of wide-view cameras 770 on the vehicle 700. In addition, any number of long-range camera(s) 798 (e.g., a long-view stereo camera pair) may be used for depth-based object detection, especially for objects for which a neural network has not yet been trained. The long-range camera(s) 798 may also be used for object detection and classification, as well as basic object tracking.

Any number of stereo cameras 768 may also be included in a front-facing configuration. In at least one embodiment, one or more of stereo camera(s) 768 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 768 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 768 may be used in addition to, or alternatively from, those described herein.

Cameras with a field of view that include portions of the environment to the side of the vehicle 700 (e.g., side-view cameras) may be used for surround view, providing information used to create and update the occupancy grid, as well as to generate side impact collision warnings. For example, surround camera(s) 774 (e.g., four surround cameras 774 as illustrated in FIG. 7B) may be positioned to on the vehicle 700. The surround camera(s) 774 may include wide-view camera(s) 770, fisheye camera(s), 360 degree camera(s), and/or the like. Four example, four fisheye cameras may be positioned on the vehicle's front, rear, and sides. In an alternative arrangement, the vehicle may use three surround camera(s) 774 (e.g., left, right, and rear), and may leverage one or more other camera(s) (e.g., a forward-facing camera) as a fourth surround view camera.

Cameras with a field of view that include portions of the environment to the rear of the vehicle 700 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 798, stereo camera(s) 768), infrared camera(s) 772, etc.), as described herein.

FIG. 7C is a block diagram of an example system architecture for the example autonomous vehicle 700 of FIG. 7A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 700 in FIG. 7C are illustrated as being connected via bus 702. The bus 702 may include a Controller Area Network (CAN) data interface (alternatively referred to herein as a “CAN bus”). A CAN may be a network inside the vehicle 700 used to aid in control of various features and functionality of the vehicle 700, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 702 is described herein as being a CAN bus, this is not intended to be limiting. For example, in addition to, or alternatively from, the CAN bus, FlexRay and/or Ethernet may be used. Additionally, although a single line is used to represent the bus 702, this is not intended to be limiting. For example, there may be any number of busses 702, which may include one or more CAN busses, one or more FlexRay busses, one or more Ethernet busses, and/or one or more other types of busses using a different protocol. In some examples, two or more busses 702 may be used to perform different functions, and/or may be used for redundancy. For example, a first bus 702 may be used for collision avoidance functionality and a second bus 702 may be used for actuation control. In any example, each bus 702 may communicate with any of the components of the vehicle 700, and two or more busses 702 may communicate with the same components. In some examples, each SoC 704, each controller 736, and/or each computer within the vehicle may have access to the same input data (e.g., inputs from sensors of the vehicle 700), and may be connected to a common bus, such the CAN bus.

The vehicle 700 may include one or more controller(s) 736, such as those described herein with respect to FIG. 7A. The controller(s) 736 may be used for a variety of functions. The controller(s) 736 may be coupled to any of the various other components and systems of the vehicle 700, and may be used for control of the vehicle 700, artificial intelligence of the vehicle 700, infotainment for the vehicle 700, and/or the like.

The vehicle 700 may include a system(s) on a chip (SoC) 704. The SoC 704 may include CPU(s) 706, GPU(s) 708, processor(s) 710, cache(s) 712, accelerator(s) 714, data store(s) 716, and/or other components and features not illustrated. The SoC(s) 704 may be used to control the vehicle 700 in a variety of platforms and systems. For example, the SoC(s) 704 may be combined in a system (e.g., the system of the vehicle 700) with an HD map 722 which may obtain map refreshes and/or updates via a network interface 724 from one or more servers (e.g., server(s) 778 of FIG. 7D).

The CPU(s) 706 may include a CPU cluster or CPU complex (alternatively referred to herein as a “CCPLEX”). The CPU(s) 706 may include multiple cores and/or L2 caches. For example, in some embodiments, the CPU(s) 706 may include eight cores in a coherent multi-processor configuration. In some embodiments, the CPU(s) 706 may include four dual-core clusters where each cluster has a dedicated L2 cache (e.g., a 2 MB L2 cache). The CPU(s) 706 (e.g., the CCPLEX) may be configured to support simultaneous cluster operation enabling any combination of the clusters of the CPU(s) 706 to be active at any given time.

The CPU(s) 706 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 706 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 708 may include an integrated GPU (alternatively referred to herein as an “iGPU”). The GPU(s) 708 may be programmable and may be efficient for parallel workloads. The GPU(s) 708, in some examples, may use an enhanced tensor instruction set. The GPU(s) 708 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 712 KB storage capacity). In some embodiments, the GPU(s) 708 may include at least eight streaming microprocessors. The GPU(s) 708 may use compute application programming interface(s) (API(s)). In addition, the GPU(s) 708 may use one or more parallel computing platforms and/or programming models (e.g., NVIDIA's CUDA).

The GPU(s) 708 may be power-optimized for best performance in automotive and embedded use cases. For example, the GPU(s) 708 may be fabricated on a Fin field-effect transistor (FinFET). However, this is not intended to be limiting and the GPU(s) 708 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 708 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 708 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 708 to access the CPU(s) 706 page tables directly. In such examples, when the GPU(s) 708 memory management unit (MMU) experiences a miss, an address translation request may be transmitted to the CPU(s) 706. In response, the CPU(s) 706 may look in its page tables for the virtual-to-physical mapping for the address and transmits the translation back to the GPU(s) 708. As such, unified memory technology may allow a single unified virtual address space for memory of both the CPU(s) 706 and the GPU(s) 708, thereby simplifying the GPU(s) 708 programming and porting of applications to the GPU(s) 708.

In addition, the GPU(s) 708 may include an access counter that may keep track of the frequency of access of the GPU(s) 708 to memory of other processors. The access counter may help ensure that memory pages are moved to the physical memory of the processor that is accessing the pages most frequently.

The SoC(s) 704 may include any number of cache(s) 712, including those described herein. For example, the cache(s) 712 may include an L3 cache that is available to both the CPU(s) 706 and the GPU(s) 708 (e.g., that is connected both the CPU(s) 706 and the GPU(s) 708). The cache(s) 712 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 704 may include an arithmetic logic unit(s) (ALU(s)) which may be leveraged in performing processing with respect to any of the variety of tasks or operations of the vehicle 700—such as processing DNNs. In addition, the SoC(s) 704 may include a floating point unit(s) (FPU(s))—or other math coprocessor or numeric coprocessor types—for performing mathematical operations within the system. For example, the SoC(s) 704 may include one or more FPUs integrated as execution units within a CPU(s) 706 and/or GPU(s) 708.

The SoC(s) 704 may include one or more accelerators 714 (e.g., hardware accelerators, software accelerators, or a combination thereof). For example, the SoC(s) 704 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 708 and to off-load some of the tasks of the GPU(s) 708 (e.g., to free up more cycles of the GPU(s) 708 for performing other tasks). As an example, the accelerator(s) 714 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 714 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 708, and by using an inference accelerator, for example, a designer may target either the DLA(s) or the GPU(s) 708 for any function. For example, the designer may focus processing of CNNs and floating point operations on the DLA(s) and leave other functions to the GPU(s) 708 and/or other accelerator(s) 714.

The accelerator(s) 714 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 706. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 714 (e.g., the hardware acceleration cluster) may include a computer vision network on-chip and SRAM, for providing a high-bandwidth, low latency SRAM for the accelerator(s) 714. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 704 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 714 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 766 output that correlates with the vehicle 700 orientation, distance, 3D location estimates of the object obtained from the neural network and/or other sensors (e.g., LiDAR sensor(s) 764 or RADAR sensor(s) 760), among others.

The SoC(s) 704 may include data store(s) 716 (e.g., memory). The data store(s) 716 may be on-chip memory of the SoC(s) 704, which may store neural networks to be executed on the GPU and/or the DLA. In some examples, the data store(s) 716 may be large enough in capacity to store multiple instances of neural networks for redundancy and safety. The data store(s) 712 may comprise L2 or L3 cache(s) 712. Reference to the data store(s) 716 may include reference to the memory associated with the PVA, DLA, and/or other accelerator(s) 714, as described herein.

The SoC(s) 704 may include one or more processor(s) 710 (e.g., embedded processors). The processor(s) 710 may include a boot and power management processor that may be a dedicated processor and subsystem to handle boot power and management functions and related security enforcement. The boot and power management processor may be a part of the SoC(s) 704 boot sequence and may provide runtime power management services. The boot power and management processor may provide clock and voltage programming, assistance in system low power state transitions, management of SoC(s) 704 thermals and temperature sensors, and/or management of the SoC(s) 704 power states. Each temperature sensor may be implemented as a ring-oscillator whose output frequency is proportional to temperature, and the SoC(s) 704 may use the ring-oscillators to detect temperatures of the CPU(s) 706, GPU(s) 708, and/or accelerator(s) 714. If temperatures are determined to exceed a threshold, the boot and power management processor may enter a temperature fault routine and put the SoC(s) 704 into a lower power state and/or put the vehicle 700 into a chauffeur to safe stop mode (e.g., bring the vehicle 700 to a safe stop).

The processor(s) 710 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 710 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 710 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 710 may further include a real-time camera engine that may include a dedicated processor subsystem for handling real-time camera management.

The processor(s) 710 may further include a high-dynamic range signal processor that may include an image signal processor that is a hardware engine that is part of the camera processing pipeline.

The processor(s) 710 may include a video image compositor that may be a processing block (e.g., implemented on a microprocessor) that implements video post-processing functions needed by a video playback application to produce the final image for the player window. The video image compositor may perform lens distortion correction on wide-view camera(s) 770, surround camera(s) 774, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 708 is not required to continuously render new surfaces. Even when the GPU(s) 708 is powered on and active doing 3D rendering, the video image compositor may be used to offload the GPU(s) 708 to improve performance and responsiveness.

The SoC(s) 704 may further include a mobile industry processor interface (MIPI) camera serial interface for receiving video and input from cameras, a high-speed interface, and/or a video input block that may be used for camera and related pixel input functions. The SoC(s) 704 may further include an input/output controller(s) that may be controlled by software and may be used for receiving I/O signals that are uncommitted to a specific role.

The SoC(s) 704 may further include a broad range of peripheral interfaces to enable communication with peripherals, audio codecs, power management, and/or other devices. The SoC(s) 704 may be used to process data from cameras (e.g., connected over Gigabit Multimedia Serial Link and Ethernet), sensors (e.g., LiDAR sensor(s) 764, RADAR sensor(s) 760, etc. that may be connected over Ethernet), data from bus 702 (e.g., speed of vehicle 700, steering wheel position, etc.), data from GNSS sensor(s) 758 (e.g., connected over Ethernet or CAN bus). The SoC(s) 704 may further include dedicated high-performance mass storage controllers that may include their own DMA engines, and that may be used to free the CPU(s) 706 from routine data management tasks.

The SoC(s) 704 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 704 may be faster, more reliable, and even more energy-efficient and space-efficient than conventional systems. For example, the accelerator(s) 714, when combined with the CPU(s) 706, the GPU(s) 708, and the data store(s) 716, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 720) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex. The DLA may further utilize metrics associated with sensor performance as input into one or more neural networks.

As another example, multiple neural networks may be run simultaneously, as is required for Level 3, 4, or 7 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 708.

In some examples, a CNN for facial recognition and vehicle owner identification may use data from camera sensors to identify the presence of an authorized driver and/or owner of the vehicle 700. The always on sensor processing engine may be used to unlock the vehicle when the owner approaches the driver door and turn on the lights, and, in security mode, to disable the vehicle when the owner leaves the vehicle. In this way, the SoC(s) 704 provide for security against theft and/or carjacking.

In another example, a CNN for emergency vehicle detection and identification may use data from microphones 796 to detect and identify emergency vehicle sirens. In contrast to conventional systems, that use general classifiers to detect sirens and manually extract features, the SoC(s) 704 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 758. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 762, until the emergency vehicle(s) passes.

The vehicle may include a CPU(s) 718 (e.g., discrete CPU(s), or dCPU(s)), that may be coupled to the SoC(s) 704 via a high-speed interconnect (e.g., PCIe). The CPU(s) 718 may include an X86 processor, for example. The CPU(s) 718 may be used to perform any of a variety of functions, including arbitrating potentially inconsistent results between ADAS sensors and the SoC(s) 704, and/or monitoring the status and health of the controller(s) 736 and/or infotainment SoC 730, for example.

The vehicle 700 may include a GPU(s) 720 (e.g., discrete GPU(s), or dGPU(s)), that may be coupled to the SoC(s) 704 via a high-speed interconnect (e.g., NVIDIA's NVLINK). The GPU(s) 720 may provide additional artificial intelligence functionality, such as by executing redundant and/or different neural networks, and may be used to train and/or update neural networks based on input (e.g., sensor data) from sensors of the vehicle 700.

The vehicle 700 may further include the network interface 724 which may include one or more wireless antennas 726 (e.g., one or more wireless antennas for different communication protocols, such as a cellular antenna, a Bluetooth antenna, etc.). The network interface 724 may be used to enable wireless connectivity over the Internet with the cloud (e.g., with the server(s) 778 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 700 information about vehicles in proximity to the vehicle 700 (e.g., vehicles in front of, on the side of, and/or behind the vehicle 700). This functionality may be part of a cooperative adaptive cruise control functionality of the vehicle 700.

The network interface 724 may include a SoC that provides modulation and demodulation functionality and enables the controller(s) 736 to communicate over wireless networks. The network interface 724 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 700 may further include data store(s) 728 which may include off-chip (e.g., off the SoC(s) 704) storage. The data store(s) 728 may include one or more storage elements including RAM, SRAM, DRAM, VRAM, Flash, hard disks, and/or other components and/or devices that may store at least one bit of data.

The vehicle 700 may further include GNSS sensor(s) 758. The GNSS sensor(s) 758 (e.g., GPS, assisted GPS sensors, differential GPS (DGPS) sensors, etc.), to assist in mapping, perception, occupancy grid generation, and/or path planning functions. Any number of GNSS sensor(s) 758 may be used, including, for example and without limitation, a GPS using a USB connector with an Ethernet to Serial (RS-232) bridge.

The vehicle 700 may further include RADAR sensor(s) 760. The RADAR sensor(s) 760 may be used by the vehicle 700 for long-range vehicle detection, even in darkness and/or severe weather conditions. RADAR functional safety levels may be ASIL B. The RADAR sensor(s) 760 may use the CAN and/or the bus 702 (e.g., to transmit data generated by the RADAR sensor(s) 760) for control and to access object tracking data, with access to Ethernet to access raw data in some examples. A wide variety of RADAR sensor types may be used. For example, and without limitation, the RADAR sensor(s) 760 may be suitable for front, rear, and side RADAR use. In some example, Pulse Doppler RADAR sensor(s) are used.

The RADAR sensor(s) 760 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 760 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 700 surroundings at higher speeds with minimal interference from traffic in adjacent lanes. The other two antennae may expand the field of view, making it possible to quickly detect vehicles entering or leaving the vehicle's 700 lane.

Mid-range RADAR systems may include, as an example, a range of up to 760 m (front) or 80 m (rear), and a field of view of up to 42 degrees (front) or 750 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 700 may further include ultrasonic sensor(s) 762. The ultrasonic sensor(s) 762, which may be positioned at the front, back, and/or the sides of the vehicle 700, may be used for park assist and/or to create and update an occupancy grid. A wide variety of ultrasonic sensor(s) 762 may be used, and different ultrasonic sensor(s) 762 may be used for different ranges of detection (e.g., 2.5 m, 4 m). The ultrasonic sensor(s) 762 may operate at functional safety levels of ASIL B.

The vehicle 700 may include LiDAR sensor(s) 764. The LiDAR sensor(s) 764 may be used for object and pedestrian detection, emergency braking, collision avoidance, and/or other functions. The LiDAR sensor(s) 764 may be functional safety level ASIL B. In some examples, the vehicle 700 may include multiple LiDAR sensors 764 (e.g., two, four, six, etc.) that may use Ethernet (e.g., to provide data to a Gigabit Ethernet switch).

In some examples, the LiDAR sensor(s) 764 may be capable of providing a list of objects and their distances for a 360-degree field of view. Commercially available LiDAR sensor(s) 764 may have an advertised range of approximately 700 m, with an accuracy of 2 cm-3 cm, and with support for a 700 Mbps Ethernet connection, for example. In some examples, one or more non-protruding LiDAR sensors 764 may be used. In such examples, the LiDAR sensor(s) 764 may be implemented as a small device that may be embedded into the front, rear, sides, and/or corners of the vehicle 700. The LiDAR sensor(s) 764, in such examples, may provide up to a 120-degree horizontal and 35-degree vertical field-of-view, with a 200 m range even for low-reflectivity objects. Front-mounted LiDAR sensor(s) 764 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 700. Available 3D flash LiDAR systems include a solid-state 3D staring array LiDAR camera with no moving parts other than a fan (e.g., a non-scanning LiDAR device). The flash LiDAR device may use a 7 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 764 may be less susceptible to motion blur, vibration, and/or shock.

The vehicle may further include IMU sensor(s) 766. The IMU sensor(s) 766 may be located at a center of the rear axle of the vehicle 700, in some examples. The IMU sensor(s) 766 may include, for example and without limitation, an accelerometer(s), a magnetometer(s), a gyroscope(s), a magnetic compass(es), and/or other sensor types. In some examples, such as in six-axis applications, the IMU sensor(s) 766 may include accelerometers and gyroscopes, while in nine-axis applications, the IMU sensor(s) 766 may include accelerometers, gyroscopes, and magnetometers.

In some embodiments, the IMU sensor(s) 766 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 766 may enable the vehicle 700 to estimate heading without requiring input from a magnetic sensor by directly observing and correlating the changes in velocity from GPS to the IMU sensor(s) 766. In some examples, the IMU sensor(s) 766 and the GNSS sensor(s) 758 may be combined in a single integrated unit.

The vehicle may include microphone(s) 796 placed in and/or around the vehicle 700. The microphone(s) 796 may be used for emergency vehicle detection and identification, among other things.

The vehicle may further include any number of camera types, including stereo camera(s) 768, wide-view camera(s) 770, infrared camera(s) 772, surround camera(s) 774, long-range and/or mid-range camera(s) 798, and/or other camera types. The cameras may be used to capture image data around an entire periphery of the vehicle 700. The types of cameras used depends on the embodiments and requirements for the vehicle 700, and any combination of camera types may be used to provide the necessary coverage around the vehicle 700. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 7A and FIG. 7B.

The vehicle 700 may further include vibration sensor(s) 742. The vibration sensor(s) 742 may measure vibrations of components of the vehicle, such as the axle(s). For example, changes in vibrations may indicate a change in road surfaces. In another example, when two or more vibration sensors 742 are used, the differences between the vibrations may be used to determine friction or slippage of the road surface (e.g., when the difference in vibration is between a power-driven axle and a freely rotating axle).

The vehicle 700 may include an ADAS system 738. The ADAS system 738 may include a SoC, in some examples. The ADAS system 738 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 760, LiDAR sensor(s) 764, and/or a camera(s). The ACC systems may include longitudinal ACC and/or lateral ACC. Longitudinal ACC monitors and controls the distance to the vehicle immediately ahead of the vehicle 700 and automatically adjust the vehicle speed to maintain a safe distance from vehicles ahead. Lateral ACC performs distance keeping, and advises the vehicle 700 to change lanes when necessary. Lateral ACC is related to other ADAS applications such as LCA and CWS.

CACC uses information from other vehicles that may be received via the network interface 724 and/or the wireless antenna(s) 726 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 700), while the I2V communication concept provides information about traffic further ahead. CACC systems may include either or both I2V and V2V information sources. Given the information of the vehicles ahead of the vehicle 700, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 760, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 760, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 700 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 700 if the vehicle 700 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 760, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 700 is backing up. Some RCTW systems include AEB to ensure that the vehicle brakes are applied to avoid a crash. RCTW systems may use one or more rear-facing RADAR sensor(s) 760, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 700, the vehicle 700 itself must, in the case of conflicting results, decide whether to heed the result from a primary computer or a secondary computer (e.g., a first controller 736 or a second controller 736). For example, in some embodiments, the ADAS system 738 may be a backup and/or secondary computer for providing perception information to a backup computer rationality module. The backup computer rationality monitor may run a redundant diverse software on hardware components to detect faults in perception and dynamic driving tasks. Outputs from the ADAS system 738 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 704.

In other examples, ADAS system 738 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 738 may be fed into the primary computer's perception block and/or the primary computer's dynamic driving task block. For example, if the ADAS system 738 indicates a forward crash warning due to an object immediately ahead, the perception block may use this information when identifying objects. In other examples, the secondary computer may have its own neural network which is trained and thus reduces the risk of false positives, as described herein.

The vehicle 700 may further include the infotainment SoC 730 (e.g., an in-vehicle infotainment system (IVI)). Although illustrated and described as a SoC, the infotainment system may not be a SoC, and may include two or more discrete components. The infotainment SoC 730 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 700. For example, the infotainment SoC 730 may radios, disk players, navigation systems, video players, USB and Bluetooth connectivity, carputers, in-car entertainment, Wi-Fi, steering wheel audio controls, hands free voice control, a heads-up display (HUD), an HMI display 734, a telematics device, a control panel (e.g., for controlling and/or interacting with various components, features, and/or systems), and/or other components. The infotainment SoC 730 may further be used to provide information (e.g., visual and/or audible) to a user(s) of the vehicle, such as information from the ADAS system 738, autonomous driving information such as planned vehicle maneuvers, trajectories, surrounding environment information (e.g., intersection information, vehicle information, road information, etc.), and/or other information.

The infotainment SoC 730 may include GPU functionality. The infotainment SoC 730 may communicate over the bus 702 (e.g., CAN bus, Ethernet, etc.) with other devices, systems, and/or components of the vehicle 700. In some examples, the infotainment SoC 730 may be coupled to a supervisory MCU such that the GPU of the infotainment system may perform some self-driving functions in the event that the primary controller(s) 736 (e.g., the primary and/or backup computers of the vehicle 700) fail. In such an example, the infotainment SoC 730 may put the vehicle 700 into a chauffeur to safe stop mode, as described herein.

The vehicle 700 may further include an instrument cluster 732 (e.g., a digital dash, an electronic instrument cluster, a digital instrument panel, etc.). The instrument cluster 732 may include a controller and/or supercomputer (e.g., a discrete controller or supercomputer). The instrument cluster 732 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 730 and the instrument cluster 732. In other words, the instrument cluster 732 may be included as part of the infotainment SoC 730, or vice versa.

FIG. 7D is a system diagram for communication between cloud-based server(s) and the example autonomous vehicle 700 of FIG. 7A, in accordance with some embodiments of the present disclosure. The system 776 may include server(s) 778, network(s) 790, and vehicles, including the vehicle 700. The server(s) 778 may include a plurality of GPUs 784(A)-584(H) (collectively referred to herein as GPUs 784), PCIe switches 782(A)-582(H) (collectively referred to herein as PCIe switches 782), and/or CPUs 780(A)-580(B) (collectively referred to herein as CPUs 780). The GPUs 784, the CPUs 780, and the PCIe switches may be interconnected with high-speed interconnects such as, for example and without limitation, NVLink interfaces 788 developed by NVIDIA and/or PCIe connections 786. In some examples, the GPUs 784 are connected via NVLink and/or NVSwitch SoC and the GPUs 784 and the PCIe switches 782 are connected via PCIe interconnects. Although eight GPUs 784, two CPUs 780, and two PCIe switches are illustrated, this is not intended to be limiting. Depending on the embodiment, each of the server(s) 778 may include any number of GPUs 784, CPUs 780, and/or PCIe switches. For example, the server(s) 778 may each include eight, sixteen, thirty-two, and/or more GPUs 784.

The server(s) 778 may receive, over the network(s) 790 and from the vehicles, image data representative of images showing unexpected or changed road conditions, such as recently commenced road-work. The server(s) 778 may transmit, over the network(s) 790 and to the vehicles, neural networks 792, updated neural networks 792, and/or map information 794, including information regarding traffic and road conditions. The updates to the map information 794 may include updates for the HD map 722, such as information regarding construction sites, potholes, detours, flooding, and/or other obstructions. In some examples, the neural networks 792, the updated neural networks 792, and/or the map information 794 may have resulted from new training and/or experiences represented in data received from any number of vehicles in the environment, and/or based on training performed at a datacenter (e.g., using the server(s) 778 and/or other servers).

The server(s) 778 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 790, and/or the machine learning models may be used by the server(s) 778 to remotely monitor the vehicles.

In some examples, the server(s) 778 may receive data from the vehicles and apply the data to up-to-date real-time neural networks for real-time intelligent inferencing. The server(s) 778 may include deep-learning supercomputers and/or dedicated AI computers powered by GPU(s) 784, such as a DGX and DGX Station machines developed by NVIDIA. However, in some examples, the server(s) 778 may include deep learning infrastructure that use only CPU-powered datacenters.

The deep-learning infrastructure of the server(s) 778 may be capable of fast, real-time inferencing, and may use that capability to evaluate and verify the health of the processors, software, and/or associated hardware in the vehicle 700. For example, the deep-learning infrastructure may receive periodic updates from the vehicle 700, such as a sequence of images and/or objects that the vehicle 700 has located in that sequence of images (e.g., via computer vision and/or other machine learning object classification techniques). The deep-learning infrastructure may run its own neural network to identify the objects and compare them with the objects identified by the vehicle 700 and, if the results do not match and the infrastructure concludes that the AI in the vehicle 700 is malfunctioning, the server(s) 778 may transmit a signal to the vehicle 700 instructing a fail-safe computer of the vehicle 700 to assume control, notify the passengers, and complete a safe parking maneuver.

For inferencing, the server(s) 778 may include the GPU(s) 784 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

In various embodiments, one or more CPU(s) 806, GPU(s) 808, and/or logic unit(s) 820 are configured to execute one or more instances of scheduling engine 122 and/or sensor fusion engine 124. Sorted measurements 292 generated by scheduling engine 122 can then be used by sensor fusion engine 124 and/or additional components to perform additional processing such as planning and control functions.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-716(N), where “N” represents any whole, positive integer. In at least one embodiment, node C.R.s 916(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-716(N) may correspond to a server having one or more of the above-mentioned computing resources. In addition, in some embodiments, the node C.R.s 916(1)-716(N) may include one or more virtual components, such as vGPUs, vCPUs, and/or the like, and/or one or more of the node C.R.s 916(1)-716(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUS, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-716(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 933, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache SparkTM (hereinafter “Spark”) that may utilize distributed file system 938 for large-scale data processing (e.g., “big data”). In at least one embodiment, job scheduler 933 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 933. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-716(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-716(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

In sum, the disclosed techniques introduce a time-window based sensor measurement scheduling engine that determines an ordering of measurements received from multiple sensors in which the measurements are sorted by detection time, and submits the measurements in the sorted order to a sensor fusion system without dropping a substantial number of measurements. Upon receiving the measurements from the sensors, the scheduling engine determines a current time window that includes camera measurements received since the most recent submission of a previous camera measurement to the sensor fusion system. The determined current time window includes camera measurements since the timestamp of the most recent submission because any measurements older than the most recent submission are out of date and could cause inconsistent state if used. The scheduling engine determines an upper boundary of the current time window based on a timestamp of the most recent camera measurement. Thus, the current time window includes the camera measurements that are candidates for submission to the fusion system. Measurements from other sensors may be outside the current time window. Any measurements from other sensors, such as RADAR, that are less than a threshold amount of time ahead of or behind the current time window can be extrapolated to a time in the current time window for comparison with the camera measurements in the current time window. The current time window is sized to correspond to the camera because extrapolation of camera measurements is less accurate than extrapolation of RADAR measurements. Although camera and RADAR sensors are described in the examples herein, other sensors may be used instead of or in addition to cameras and/or RADAR. Thus, the current time window is sized to include measurements that are available from the sensor having the lowest extrapolation accuracy. Measurements from other sensors having higher extrapolation accuracy can be extrapolated into the current time window. The scheduling engine uses the sensor detection times associated with the measurements in the determination of the boundaries of the current time window and also in comparisons between measurements, so the measurement ordering determined by the scheduling engine is based on detection times of the measurements.

The scheduling engine selects the latest sensor measurement in a time range for each sensor type. For example, if the measurements are from cameras and RADAR sensors as described above, then the scheduling engine selects the latest camera measurement and the latest RADAR measurement. Since the current time window is sized to include the available camera measurements, the scheduling engine selects the latest camera measurement from the current time window. There may be RADAR measurements outside the current time window, and the scheduling engine selects a latest RADAR measurement that is in the current time window or within a threshold amount of time ahead of or behind the current time window. If the latest RADAR measurement is ahead of or behind the current time window (by less than the threshold amount of time), then the scheduling engine extrapolates the latest RADAR measurement to determine a predicted RADAR measurement that is based on a time in the current time window. The extrapolation enables the scheduling engine to compare measurements having timestamps outside the time window to measurements having timestamps in the time window. The scheduling engine then sorts the selected measurements based on their timestamps in the current time window, which are the timestamps of the extrapolated measurements for measurements that were extrapolated. The scheduling engine submits the selected measurements to the fusion system in the sorted order. Since the scheduling engine selects a sensor measurement for each sensor type prior to submitting the measurements to the fusion system for processing, measurements of a given sensor type are not dropped for being older than measurements of other sensor types that have already been processed. The use of the current time window enables the disclosed techniques to accommodate a wider range of input timestamps than in other approaches that use the fusion system cycle to bound the measurements for sorting.

One technical advantage of the disclosed techniques relative to the prior solutions is the ability to accurately track objects using input from multiple sensors that generate measurements at different and/or varying rates. Prior approaches do not process measurements from multiple sensors in order of detection times if the measurements are out of order across sensors, as can occur when sensors generate measurements at different and/or varying rates. Further, prior approaches can drop a substantial number of measurements in certain timing scenarios, thereby reducing object tracking accuracy. The disclosed scheduling engine uses a time window for measurements and thus can accommodate a wider range of input timestamps. The scheduling engine correctly sorts the measurements received from multiple sensors into an order based on detection times of the measurements, even if the measurements are received at different rates, out of order across sensors, and/or out of order across cycles. Thus, measurements across the wider range of timestamps can be sorted or extrapolated to align with the resulting processing schedule.

Another technical advantage of the disclosed techniques is that the disclosed scheduling engine does not use or allocate additional memory to buffer or otherwise store measurements. Instead, the scheduling engine receives measurements, sorts the measurements, and provides the measurements to a sensor fusion system during a fusion cycle, without allocating additional memory buffers in which to store the measurements. Accordingly, the disclosed techniques are faster and less resource-intensive than prior approaches that use memory to temporarily store, e.g., buffer, measurements prior to sorting and providing the measurements to a sensor fusion system. Another technical advantage of the disclosed techniques is the ability to perform accurate object tracking because measurements from multiple sensors are dropped less frequently than in prior approaches. Dropping fewer measurements results in improved accuracy of sensor input processing and object tracking in autonomous or semi-autonomous systems.

1. In some embodiments, a method comprises receiving a plurality of input measurements, individual input measurements of the plurality of input measurements being associated with a respective sensor; identifying a current time window having a lower boundary determined based at least on a first timestamp of a first measurement generated using a first sensor of a first sensor type and provided to a sensor data recipient, the current time window further having an upper boundary determined based at least on a second timestamp of a second measurement included in the plurality of input measurements, the second measurement being generated using a second sensor; determining a plurality of output measurements in the current time window, the plurality of output measurements including a third measurement generated using the first sensor and having a third timestamp in the current time window, the plurality of output measurements further including a predicted measurement associated with the second sensor, the predicted measurement extrapolated from an actual measurement generated using the second sensor, the actual measurement having a fourth timestamp in a second time window adjacent to the current time window; sorting the plurality of output measurements based at least on the respective timestamp associated with the output measurements; and performing one or more operations using a machine based at least on the sorted plurality of output measurements.

2. The method of clause 1, wherein the first timestamp corresponds to a most recent measurement provided to the sensor data recipient.

3. The method of clause 1, wherein the second sensor includes a camera, and wherein the second timestamp corresponds to a most recent camera measurement included in the plurality of input measurements.

4. The method of clause 1, wherein each input measurement in the plurality of input measurements is further associated with a timestamp indicating a detection time of the input measurement.

5. The method of clause 4, wherein the first timestamp indicates a time at which the first sensor generated the first measurement.

6. The method of clause 1, wherein the third measurement is a most recent measurement generated using the first sensor of the first sensor type in the current time window.

7. The method of clause 1, wherein the actual measurement is a most recent measurement generated using the second sensor in the second time window adjacent to the current time window.

8. The method of clause 1, wherein the predicted measurement is in the current time window.

9. The method of clause 8, wherein the predicted measurement in the current time window is extrapolated based at least on one or more characteristics of the actual measurement and a time difference between the fourth timestamp of the actual measurement and a predicted timestamp of the predicted measurement in the current time window.

10. The method of clause 9, wherein the predicted timestamp of the predicted measurement is determined based at least on one or more of an upper boundary of the current time window or a lower boundary of the current time window.

11. The method of clause 10, wherein the predicted timestamp of the predicted measurement is based at least on the third timestamp of the third measurement having the third timestamp in the current time window.

12. The method of clause 1, wherein the second time window comprises a back prediction time window having a lower boundary that corresponds to the upper boundary of the current time window.

13. The method of clause 12, wherein the back prediction time window has an upper boundary that is greater than the lower boundary of the back prediction time window by a predetermined amount of time.

14. The method of clause 1, wherein the second time window comprises a forward prediction time window having an upper boundary that corresponds to the lower boundary of the current time window.

15. The method of clause 14, wherein the forward prediction time window has a lower boundary that is less than the upper boundary of the forward prediction time window by a predetermined amount of time.

16. The method of clause 1, wherein the sensor data recipient comprises a sensor fusion engine.

17. The method of clause 1, wherein the first sensor type comprises one or more of a RADAR, LiDAR, or ultrasonic sensor type, and the second sensor type comprises one or more of a RADAR, LiDAR, or ultrasonic sensor type.

18. In some embodiments, a processor comprises one or more processing units to perform operations comprising: receiving a plurality of input measurements, individual input measurements of the plurality of input measurements being associated with a respective sensor; identifying a current time window having a lower boundary determined based at least on a first timestamp of a first measurement generated using a first sensor of a first sensor type and provided to a sensor data recipient, the current time window further having an upper boundary determined based at least on a second timestamp of a second measurement included in the plurality of input measurements, the second measurement being generated using a second sensor; determining a plurality of output measurements in the current time window, the plurality of output measurements including a third measurement generated using the first sensor and having a third timestamp in the current time window, the plurality of output measurements further including a predicted measurement associated with the second sensor, the predicted measurement extrapolated from an actual measurement generated using the second sensor, the actual measurement having a fourth timestamp in a second time window adjacent to the current time window; sorting the plurality of output measurements based at least on the respective timestamp associated with the output measurements; and performing one or more operations using a machine based at least on the sorted plurality of output measurements.

19. The processor of clause 18, wherein the processor is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system for generating or presenting at least one of virtual reality content, augmented reality content, or mixed reality content; a system implemented using a robot; a system for performing conversational AI operations; a system implementing one or more large language models (LLMs); a system for generating synthetic data; a system incorporating one or more virtual machines (VMs); a system implemented at least partially in a data center; or a system implemented at least partially using cloud computing resources.

20. In some embodiments, a system comprises one or more processors to perform operations comprising receiving a plurality of input measurements, individual input measurements of the plurality of input measurements being associated with a respective sensor; identifying a current time window having a lower boundary determined based at least on a first timestamp of a first measurement generated using a first sensor of a first sensor type and provided to a sensor data recipient, the current time window further having an upper boundary determined based at least on a second timestamp of a second measurement included in the plurality of input measurements, the second measurement being generated using a second sensor; determining a plurality of output measurements in the current time window, the plurality of output measurements including a third measurement generated using the first sensor and having a third timestamp in the current time window, the plurality of output measurements further including a predicted measurement associated with the second sensor, the predicted measurement extrapolated from an actual measurement generated using the second sensor, the actual measurement having a fourth timestamp in a second time window adjacent to the current time window; sorting the plurality of output measurements based at least on the respective timestamp associated with the output measurements; and performing one or more operations using a machine based at least on the sorted plurality of output measurements.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

While the preceding is directed to embodiments of the present disclosure, other and further embodiments of the disclosure may be devised without departing from the basic scope thereof, and the scope thereof is determined by the claims that follow.

What is claimed is:

1. A method, comprising:
receiving a plurality of input measurements, individual input measurements of the plurality of input measurements being associated with a respective sensor;
identifying a current time window having a lower boundary determined based at least on a first timestamp of a first measurement generated using a first sensor of a first sensor type and provided to a sensor data recipient, the current time window further having an upper boundary determined based at least on a second timestamp of a second measurement included in the plurality of input measurements, the second measurement being generated using a second sensor;
determining a plurality of output measurements in the current time window, the plurality of output measurements including a third measurement generated using the first sensor and having a third timestamp in the current time window, the plurality of output measurements further including a predicted measurement associated with the second sensor, the predicted measurement extrapolated from an actual measurement generated using the second sensor, the actual measurement having a fourth timestamp in a second time window adjacent to the current time window;
sorting the plurality of output measurements based at least on the respective timestamp associated with the output measurements; and
performing one or more operations using a machine based at least on the sorted plurality of output measurements.

2. The method of claim 1, wherein the first timestamp corresponds to a most recent measurement provided to the sensor data recipient.

3. The method of claim 1, wherein the second sensor includes a camera, and wherein the second timestamp corresponds to a most recent camera measurement included in the plurality of input measurements.

4. The method of claim 1, wherein each input measurement in the plurality of input measurements is further associated with a timestamp indicating a detection time of the input measurement.

5. The method of claim 4, wherein the first timestamp indicates a time at which the first sensor generated the first measurement.

6. The method of claim 1, wherein the third measurement is a most recent measurement generated using the first sensor of the first sensor type in the current time window.

7. The method of claim 1, wherein the actual measurement is a most recent measurement generated using the second sensor in the second time window adjacent to the current time window.

8. The method of claim 1, wherein the predicted measurement is in the current time window.

9. The method of claim 8, wherein the predicted measurement in the current time window is extrapolated based at least on one or more characteristics of the actual measurement and a time difference between the fourth timestamp of the actual measurement and a predicted timestamp of the predicted measurement in the current time window.

10. The method of claim 9, wherein the predicted timestamp of the predicted measurement is determined based at least on one or more of an upper boundary of the current time window or a lower boundary of the current time window.

11. The method of claim 10, wherein the predicted timestamp of the predicted measurement is based at least on the third timestamp of the third measurement having the third timestamp in the current time window.

12. The method of claim 1, wherein the second time window comprises a back prediction time window having a lower boundary that corresponds to the upper boundary of the current time window.

13. The method of claim 12, wherein the back prediction time window has an upper boundary that is greater than the lower boundary of the back prediction time window by a predetermined amount of time.

14. The method of claim 1, wherein the second time window comprises a forward prediction time window having an upper boundary that corresponds to the lower boundary of the current time window.

15. The method of claim 14, wherein the forward prediction time window has a lower boundary that is less than the upper boundary of the forward prediction time window by a predetermined amount of time.

16. The method of claim 1, wherein the sensor data recipient comprises a sensor fusion engine.

17. The method of claim 1, wherein the first sensor type comprises one or more of a RADAR, LiDAR, or ultrasonic sensor type, and the second sensor type comprises one or more of a RADAR, LiDAR, or ultrasonic sensor type.

18. A processor comprising:
one or more processing units to perform operations comprising:
receiving a plurality of input measurements, individual input measurements of the plurality of input measurements being associated with a respective sensor;
identifying a current time window having a lower boundary determined based at least on a first timestamp of a first measurement generated using a first sensor of a first sensor type and provided to a sensor data recipient, the current time window further having an upper boundary determined based at least on a second timestamp of a second measurement included in the plurality of input measurements, the second measurement being generated using a second sensor;
determining a plurality of output measurements in the current time window, the plurality of output measurements including a third measurement generated using the first sensor and having a third timestamp in the current time window, the plurality of output measurements further including a predicted measurement associated with the second sensor, the predicted measurement extrapolated from an actual measurement generated using the second sensor, the actual measurement having a fourth timestamp in a second time window adjacent to the current time window;
sorting the plurality of output measurements based at least on the respective timestamp associated with the output measurements; and
performing one or more operations using a machine based at least on the sorted plurality of output measurements.

19. The processor of claim 18, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, augmented reality content, or mixed reality content;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

20. A system comprising:
one or more processors to perform operations comprising:
receiving a plurality of input measurements, individual input measurements of the plurality of input measurements being associated with a respective sensor;
identifying a current time window having a lower boundary determined based at least on a first timestamp of a first measurement generated using a first sensor of a first sensor type and provided to a sensor data recipient, the current time window further having an upper boundary determined based at least on a second timestamp of a second measurement included in the plurality of input measurements, the second measurement being generated using a second sensor;
determining a plurality of output measurements in the current time window, the plurality of output measurements including a third measurement generated using the first sensor and having a third timestamp in the current time window, the plurality of output measurements further including a predicted measurement associated with the second sensor, the predicted measurement extrapolated from an actual measurement generated using the second sensor, the actual measurement having a fourth timestamp in a second time window adjacent to the current time window;
sorting the plurality of output measurements based at least on the respective timestamp associated with the output measurements; and
performing one or more operations using a machine based at least on the sorted plurality of output measurements.
